(19) United States
(12) Patent Application Publication
(10) Pub. No.: US 2024/0231325 A1
(43) Pub. Date: Jul. 11, 2024

(54) INFORMATION PROCESSING DEVICE, REMOTE OPERATION SYSTEM, AND INFORMATION PROCESSING METHOD

(71) Applicant: SONY GROUP CORPORATION, TOKYO (JP)

(72) Inventor: PAVEL ADODIN, TOKYO (JP)

(21) Appl. No.: 18/563,027

(22) PCT Filed: Mar. 1, 2022
(86) PCT No.: PCT/JP2022/008531

§ 371 Date: Nov. 21, 2023

(30) Foreign Application Priority Data
May 31, 2021 (JP) 2021-090761

(51) Int. Cl. G05B 19/4155; G06N 5/022

(52) U.S. Cl. CPC G05B 19/4155; G06N 5/022; G05B 2219/34208

(57) ABSTRACT

An information processing device (30) includes a prediction unit (321) that predicts, based on an action executed by an operation unit (120) and step information capable of identifying a work step, a next action to be executed in a next step by the operation unit (120) in accordance with a remote operation, and a motion control unit (323) that controls the operation unit (120) so as to assist in the remote operation of the operation unit (120) based on a relationship between the predicted next action, operation information (D10) about the remote operation, and an object to be operated by the operation unit (120).

### FIELD

The present disclosure relates to an information processing device, a remote operation system, and an information processing method.

### BACKGROUND

A system that controls a slave device existing at a remote location by a master-slave control method is known. Patent Literature 1 discloses a technique for determining whether data transmission between a master device and a slave device is normal or abnormal, controlling an operation of the slave device in accordance with a command value in a case where the data transmission is normal, and controlling an operation of the slave device in accordance with a predicted command value in a case where the data transmission is abnormal.

### CITATION LIST

### Patent Literature

Patent Literature 1: JP 2019-217557 A

### SUMMARY

### Technical Problem

In the conventional technique, in a case where the operator remotely controls the motion of the robot as the slave device, the executable task is limited by the skill level and the operation skill of the operator, and the performance of the input device, and it is difficult to smoothly operate the robot.

Therefore, the present disclosure provides an information processing device, a remote operation system, and an information processing method capable of improving operability of an operation unit by a remote operation by an operator.

### Solution to Problem

In order to solve the above problem, an information processing device according to one embodiment of the present disclosure includes: a prediction unit that predicts, based on an action executed by an operation unit and step information capable of identifying a work step, a next action to be executed in a next step by the operation unit in accordance with a remote operation; and a motion control unit that controls the operation unit so as to assist in the remote operation of the operation unit based on a relationship between the predicted next action, operation information about the remote operation, and an object to be operated by the operation unit.

In order to solve the above problem, a remote operation system according to one embodiment of the present disclosure includes: an operation unit; an information processing device; and an operation device that remotely operates the operation unit, wherein the information processing device includes a prediction unit that predicts a next action to be executed in a next step by the operation unit in accordance with a remote operation based on an action executed by the operation unit and step information capable of identifying a work step, and a motion control unit that controls the operation unit so as to assist in the remote operation of the operation unit based on a relationship between the predicted next action, operation information about the remote operation, and an object to be operated by the operation unit.

In order to solve the above problem, an information processing method according to one embodiment of the present disclosure performed by a computer, the method includes: predicting, based on an action executed by an operation unit and step information capable of identifying a work step, a next action to be executed in a next step by the operation unit in accordance with a remote operation; and controlling the operation unit so as to assist in the remote operation of the operation unit based on a relationship between the predicted next action, operation information about the remote operation, and an object to be operated by the operation unit.

### BRIEF DESCRIPTION OF DRAWINGS

FIG. 1 is a diagram for describing an example of a remote operation system according to the embodiment.

FIG. 2 is a diagram illustrating an example of step information used by the remote operation system according to the embodiment.

FIG. 3 is a diagram for describing an example of a plurality of steps in the remote operation system according to the embodiment.

FIG. 4 is a diagram for explaining an outline of a process in the remote operation system according to the embodiment.

FIG. 5 is a diagram for explaining an example of predictions of an action and an object.

FIG. 6 is a configuration diagram illustrating an example of a configuration of an operation device according to the embodiment.

FIG. 7 is a diagram illustrating a configuration example of a robot according to the embodiment.

FIG. 8 is a diagram for describing an example of a process P1 of the information processing device according to the embodiment.

FIG. 9 is a diagram for describing an example of a process P2 of the information processing device according to the embodiment.

FIG. 10 is a diagram for describing an example of a process P3 of the information processing device according to the embodiment.

FIG. 11 is a diagram for describing an example of a track change in the control assist according to the embodiment.

FIG. 12 is a diagram for describing an example of a speed increase in the control assist according to the embodiment.

FIG. 13 is a diagram for describing an example of automation in the control assist according to the embodiment.

FIG. 14 is a diagram for describing an example of input invalidation in the control assist according to the embodiment.

FIG. 15 is a flowchart illustrating an example of a processing procedure related to process control of the information processing device.

FIG. 16 is a diagram for describing an example of action prediction in consideration of preconditions for the information processing device.

FIG. 17 is a diagram for explaining a modification of the process P2 of the information processing device according to the embodiment.

FIG. 18 is a flowchart illustrating a modification of a processing procedure related to process control of the information processing device.

FIG. 19 is a flowchart illustrating another modification of the processing procedure related to process control of the information processing device.

FIG. 20 is a flowchart illustrating the continuation of the processing procedure illustrated in FIG. 19.

FIG. 21 is a hardware configuration diagram illustrating an example of a computer that implements functions of an information processing device.

### DESCRIPTION OF EMBODIMENTS

Hereinafter, the embodiments of the present disclosure will be described in detail with reference to the drawings. In the following embodiments, substantially the same parts are denoted by the same reference signs, and a duplicate description will be omitted.

### Embodiment

### Outline of Remote Operation System According to Embodiment

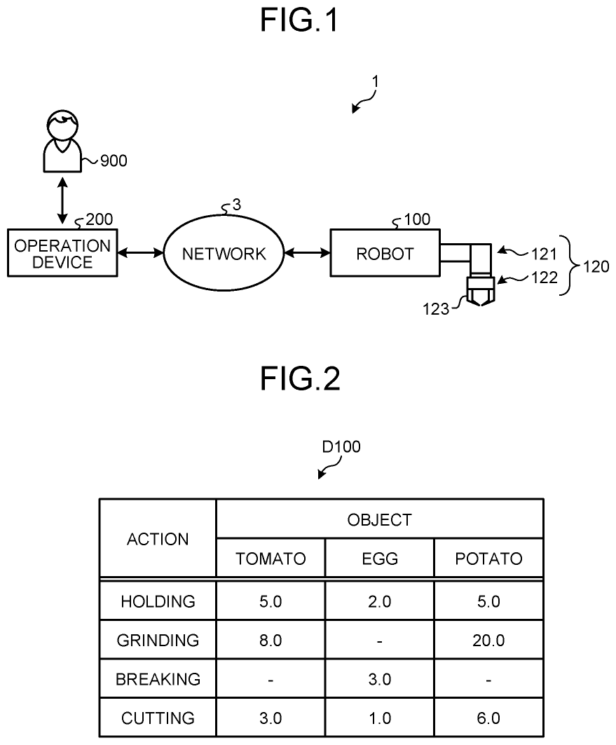

FIG. 1 is a diagram for describing an example of a remote operation system according to the embodiment. A remote operation system 1 illustrated in FIG. 1 is, for example, a system in which an operator 900 remotely operates an operation target. The operation target includes, for example, a robot 100, a medical device, a manufacturing device, facility equipment, a moving device, and the like. The remote operation system 1 can be used for work having a plurality of steps. In the following description, the remote operation system 1 will be described as an example of a system in which the operator 900 remotely operates the robot 100 to perform cooking.

The remote operation system 1 includes the robot 100 and an operation device 200 that remotely operates the robot 100. The robot 100 and the operation device 200 are configured to be connectable to a network 3. The robot 100 and the operation device 200 are configured to be able to communicate with each other via the network 3 or directly communicate with each other without the network 3.

The robot 100 is, for example, a robot imitating a humanoid, and is a robot that performs cooking at home, in a restaurant, or the like. The robot 100 includes an operation unit 120 capable of operating an operation target. The operation unit 120 is a movable unit of the robot 100. The number of operation units 120 is arbitrary. The operation unit 120 includes, for example, an arm 121 and a hand 122. The arm 121 is, for example, a 7-degree-of-freedom arm. The hand 122 is provided at the distal end of the arm 121 so as to be able to operate the operation target. The hand 122 has a plurality of movable fingers 123. A pressure detection unit that detects pressure at the time of contact is provided at the tip of the finger 123. The pressure detection unit includes, for example, a force tactile sensor of a capacitance change type, an electric resistance change type, or an electromagnetic induction type. The hand 122 is configured to be able to hold foodstuff, a cooking utensil, and the like with the plurality of fingers 123. The robot 100 has a function of performing cooking by controlling driving of the arm 121, the hand 122, and the like, for example.

The operation device 200 is provided outside the robot 100, for example. The operation device 200 has a function of receiving an operation by the operator 900 and supplying operation information about the operation to the robot 100. The operation device 200 is configured to be able to supply, for example, sensor information, position information about an object, and information indicating a posture, a line-of-sight direction, and the like of the operator 900 to the robot 100, and these pieces of information can be included in the operation information. The operation device 200 has a function of presenting, to the operator 900, motion information capable of identifying a motion state or the like of the robot 100. The motion information includes information indicating, for example, the state of the operation unit 120 of the robot 100, the state of the operation target, the positional relationship between the robot 100 and the operation target, and the like.

The remote operation system 1 can realize the remote operation by the operator 900 in cooking having a recipe, work having a work procedure manual, and the like. In the present embodiment, a case where the remote operation system 1 realizes remote operation of cooking having a recipe will be described. The recipe has, for example, a plurality of actions, and the order of the plurality of actions can be identified. The recipe indicates information on an object targeted by each of the plurality of actions. The recipe indicates a sequence of actions and their corresponding objects. The cooking recipe includes a plurality of actions and a sequence (procedure) of the plurality of actions as a step of cooking (work).

Furthermore, the acting force required when the robot 100 handles an object depends not only on the object but also on an action related to the object. Therefore, the remote operation system 1 includes information such as an upper limit value and a lower limit value of the acting force defined by a combination of the action and the object in the recipe.

In the present embodiment, the remote operation system 1 provides a function of assisting in a remote operation of a recipe in which an action and a sequence are registered. Assisting in the remote operation includes, for example, eliminating the need for the operation by the operator 900, pre-reading the operation, improving the efficiency of the motion of the operation unit 120, and the like. The remote operation system 1 realizes an assist in the remote operation using step information related to an object targeted by an action. The object includes, for example, objects such as foodstuff and cooking utensils.

FIG. 2 is a diagram illustrating an example of step information D100 used by the remote operation system 1 according to the embodiment. The step information D100 illustrated in FIG. 2 is information capable of identifying a sequence of a plurality of steps corresponding to cooking, and is information corresponding to a plurality of kinds of cooking. The step information D100 includes information indicating a step in which the robot 100 or the operation unit 120 can operate an object. The step information D100 is, for example, information corresponding to a plurality of recipes, and is constructed in a database or the like.

In the example illustrated in FIG. 2, the step information D100 is information indicating the acting force of the robot 100 corresponding to an action and an object related to cooking. The action of the step information D100 includes, for example, items such as holding, grinding, breaking, and cutting (cut). The object of the step information D100 includes, for example, items such as tomato, egg, and potato. The step information D100 indicates a maximum allowable acting force of the operation unit 120 when performing an action with respect to the action of “gripping”. The step information D100 indicates the minimum necessary acting force of the operation unit 120 when an action is performed with respect to the actions of “grinding”, “breaking”, and “cutting”.

The step information D100 indicates that, in a case where the object is a tomato, the acting force of the robot 100 on the action of holding is 5.0 N. The step information D100 indicates that in a case where the object is a tomato, the acting force of the robot 100 on the grinding action is 8.0 N. The step information D100 indicates that in a case where the object is a tomato, the robot 100 does not operate with respect to the breaking action. The step information D100 indicates that in a case where the object is a tomato, the acting force of the robot 100 on the cutting action is 3.0 N.

In the example illustrated in FIG. 2, in order to simplify the description, the step information D100 indicates some items of actions and objects, but the present invention is not limited thereto. For example, the step information D100 can be information indicating a relationship between a cooking utensil and an action with the object as the cooking utensil. The step information D100 may be configured to indicate a relationship between an action and an object for each step of cooking.

For example, the recipe does not describe preparation, movement/replacement, washing, and the like related to the operation of cooking. The preparation includes, for example, preparation actions for a cooking space, a cooking utensil, an oven, and the like. The movement/replacement includes, for example, actions for tableware, foodstuff, cooking utensils, and the like. Washing includes, for example, actions for tableware, foodstuffs, and the like. Therefore, the step information D100 includes or associates a step (procedure) described in the recipe and a preliminary step not described in the recipe.

### Example of Relationship Between Step and Process in Remote Operation System

For example, in a case of cooking where there is a recipe, the operator 900 may sequentially perform the actions registered in the recipe. In this case, in the remote operation system 1, in a case where the operator 900 operates the operation device 200, the operation device 200 transmits operation information corresponding to the operation to the robot 100. The remote operation system 1 causes the operation unit 120 to remotely operates the operation target by moving the operation unit 120 based on the operation information received by the robot 100.

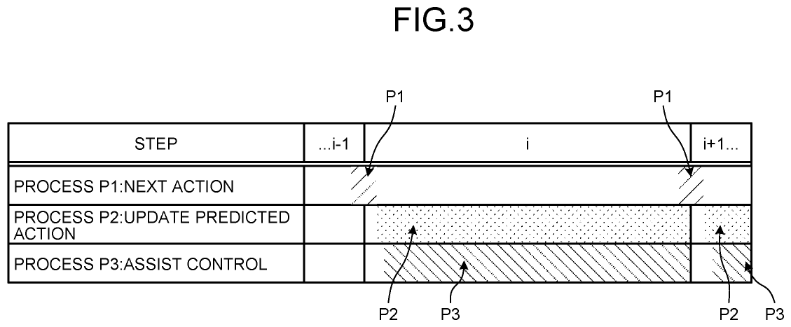

FIG. 3 is a diagram for describing an example of a plurality of steps in the remote operation system according to the embodiment. As illustrated in FIG. 3, the robot 100 can execute a plurality of processes for each step in a case of executing actions indicated by each of the plurality of steps in order of the steps. In the example illustrated in FIG. 3, the plurality of processes includes a process P1, a process P2, and a process P3. The process P1 is a process of predicting the next action of the next step or the current step. The next action means, for example, an action to be executed next. The process P2 is a process of predicting the action and object of the current step and updating the next action predicted in the process P1. The process P3 is a process of assisting the operator 900 in the remote operation.

In the example illustrated in FIG. 3, in order to simplify the description, the robot 100 executes three consecutive step(i−1), step(i), and step(i+1) among the plurality of steps. i is an integer corresponding to the step. The step illustrated in FIG. 3 indicates that the step proceeds to the next step(i) when the step(i−1) ends, and the step proceeds to the next step(i−1) when the step(i) ends.

For example, it is assumed that the operator 900 operates the operation device 200 so as to execute the action in the step(i−1) registered in the step information D100. In this case, the robot 100 executes the process P1, the process P2, and the process P3 in a case where the action in the step(i−1) is completed. FIG. 3 illustrates an example of execution timings of the process P1, the process P2, and the process P3.

When the action in the step(i−1) ends, the robot 100 executes the process P1 in at least one of the step(i−1) and the step(i) and predicts a next action in the next step(i). When the process P1 ends, the robot 100 executes the process P2 and predicts an action and an object in step(i) based on a remote operation by the operator 900 and a next action. The robot 100 can execute the process P2 at any time in the step(i). In a case of executing the process P2, the robot 100 controls the robot 100 by combining the operation of the robot 100 suitable for the action based on the prediction result of the process P2 and the remote operation by the operator 900, thereby assisting the operator in the remote operation.

### Outline of Process in Remote Operation System

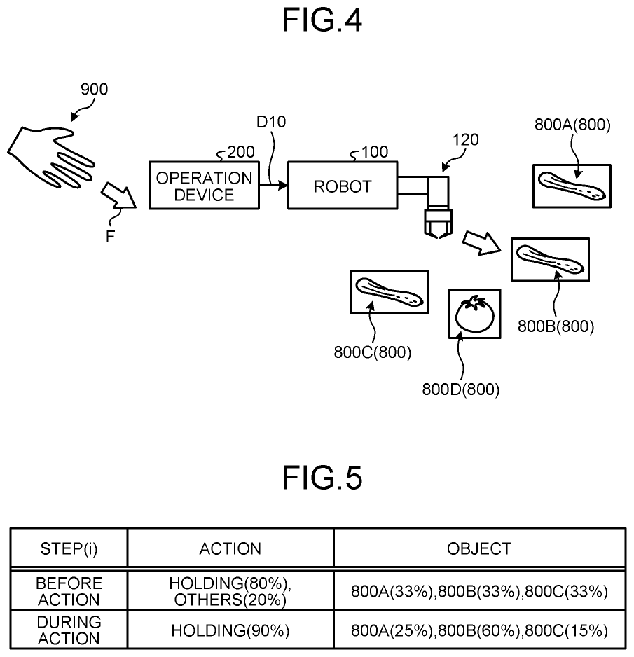

FIG. 4 is a diagram for describing an outline of a process in the remote operation system 1 according to the embodiment. FIG. 5 is a diagram for explaining an example of prediction of an action and an object. In the example illustrated in FIG. 4, the operator 900 operates the operation device 200 to carry cucumber to a cutting board. In this case, the information processing device 30 acquires the step information D100 in which there is a step of cutting a cucumber or the step information D100 corresponding to an object 800 around the robot 100. Therefore, the step information D100 includes a step of cutting a cucumber.

When the action in the step(i−1) ends, the operator 900 inputs, to the operation device 200, operation information D10 for moving the operation unit 120 to the object 800 of “cucumber” while confirming the relationship between the plurality of objects 800 and the operation unit 120 with an image or the like. The operation device 200 transmits the input operation information D10 to the robot 100.

The robot 100 controls the motion of the operation unit 120 such that the operation unit 120 moves according to the operation information D10 from the operation device 200. As a result, the operation unit 120 moves toward the object 800 of “cucumber”. When the action of movement of the operation unit 120 ends, the robot 100 predicts a next action to be executed by the operation unit 120 in the next step(i) as the process P1. For example, it is assumed that the step information D100 corresponding to the recipe includes a step for cooking a cucumber on a cutting board. In this case, the robot 100 predicts an action of “holding” as the next action based on the action in the step(i−1) and the step information D100.

As the process P2, the robot 100 analyzes the next action of “holding” predicted in the process P1 and the information about the object 800 to perform the process of predicting the action in the step(i) and the object 800 to be operated as needed. For example, the robot 100 acquires information such as the position and shape of the object 800 based on a recognition result of an image obtained by imaging the object 800 in the movement direction of the operation unit 120. In the example illustrated in FIG. 4, the robot 100 recognizes three cucumbers indicated by an object 800A, an object 800B, and an object 800C and one tomato indicated by an object 800D. Note that, hereinafter, in a case where the object 800A, the object 800B, the object 800C, and the object 800D are not distinguished, the object 800A, the object 800B, the object 800C, and the object 800D are referred to as an “object 800”.

Before the action in the step(i), as illustrated in FIG. 5, the robot 100 predicts that the probability that the next action is “holding” is 80% and the probability that the next action is other actions is 20%. In FIG. 5, in the predicted action, before the action in the step(i) corresponds to the next action. The robot 100 predicts a probability that each of the object 800A, the object 800B, and the object 800C is to be operated with respect to the action of “holding”. In the example illustrated in FIG. 4, since the movement direction of the operation unit 120 is not determined before the action in the step(i), the robot 100 predicts that the probability of operating each of the object 800A, the object 800B, and the object 800C is 33%.

During the action in the step(i), the operator 900 performs an operation of moving the operation unit 120 to the object 800B. The robot 100 calculates a track of the operation unit 120 based on the operation information D10 from the operation device 200, and controls the motion of the operation unit 120 so that the motion is on the track. In this case, the robot 100 predicts the probability that the object 800 is to be operated based on the motion direction, the speed, and the like indicated by the operation information D10.

As illustrated in FIG. 5, the robot 100 predicts a probability that the next action is “holding” as 90%, and predicts the probability higher than that before the action. Based on the positional relationship between the operation unit 120 and the object 800, the robot 100 predicts 25% for the object 800A, 60% for the object 800B, and 15% for the object 800C as the probability that the objects are to be operated with respect to the action. That is, the robot 100 predicts that the probability of the object 800B in the operation direction of the operation unit 120 is high, and predicts that the probabilities of the other objects 800A and 800C is low according to the deviation degree from the operation direction.

In addition, during the action in the step(i), it is assumed that the operator 900 tries to operate an object 800 that does not correspond to the action predicted before the action. In this case, the robot 100 can perform the process of reviewing the action corresponding to the object 800 by predicting that the probability of the object 800 is high.

As the process P3, the robot 100 assists the operator 900 in the remote operation based on the combination of the action and the object 800 predicted in the process P2. In the example illustrated in FIG. 4, the robot 100 assists in the remote operation by changing and adjusting the track of the operation unit 120 that holds the object 800B, increasing the speed, automatically executing the task of the operation unit 120 for holding, and invalidating the input by the operator 900. The algorithm of assisting in the remote operation will be described later.

Thereafter, when the object 800B is moved to a cutting board, the operator 900 remotely operates an action of cutting the object 800B with a kitchen knife as a step(i+1). The robot 100 predicts that the next action will be cutting with a kitchen knife in the process P1, and assists in the remote operation for the motion of cutting the object 800B by holding the kitchen knife by the operation unit 120. For example, the robot 100 assists in an operation of the operation unit 120 holding a kitchen knife or assists in an action of cutting the object 800B. For example, the robot 100 may automate the motion of the operation unit 120 so as to cut the object 800B with the cutting method indicated by the recipe of the step information D100. For example, in a case where the cutting method is round cutting, cutting into strips, or the like, the robot 100 assists in an action of cutting the object 800B with the cutting method, so that complicated remote operation by the operator 900 can be made unnecessary.

In the present embodiment, the robot 100 controls the motion of the operation unit 120 so as to change the motion of the operation unit 120 based on the operation information D10 of the operator 900 by executing the process P1, the process P2, and the process P3 for one step. In a case where not assisting in the remote operation in the process P3, the robot 100 controls the motion of the operation unit 120 so that motion of the operation unit 120 based on the operation information D10 is obtained.

### Configuration Example of Operation Device According to Embodiment

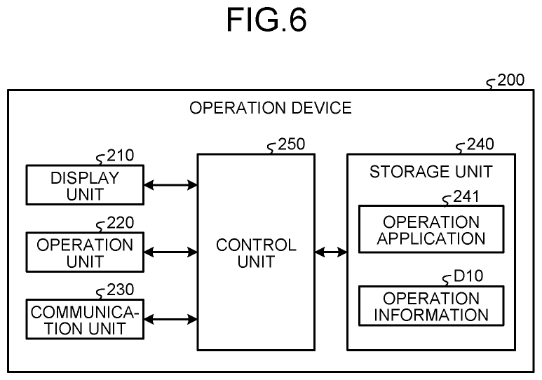

FIG. 6 is a configuration diagram illustrating an example of a configuration of the operation device 200 according to the embodiment. As illustrated in FIG. 6, the operation device 200 includes a display unit 210, an input unit 220, a communication unit 230, a storage unit 240, and a control unit 250. The control unit 250 is electrically connected to the display unit 210, the input unit 220, the communication unit 230, and the storage unit 240.

The display unit 210 includes, for example, a display panel such as a liquid crystal display (LCD) or an organic electroluminescence display (organic EL display). The display unit 210 can display information such as characters, figures, and images according to a signal input from the control unit 250. The information displayed on the display unit 210 includes various types of information such as the state of the robot 100 and an image to be operated.

The input unit 220 includes one or a plurality of devices for receiving an operation (input) by the operator 900. The device includes, for example, an operation lever, a joystick, a glove attached to the hand of the operator 900, and the like. The input unit 220 can supply the operation information D10 corresponding to the received operation to the control unit 250.

The communication unit 230 is a communication device that communicates with the robot 100. The communication unit 230 supplies various types of information received from the robot 100 to the control unit 250. The communication unit 230 transmits various types of information instructed by the control unit 250 to the corresponding robot 100. The communication protocol supported by the communication unit 230 is not particularly limited, and the communication unit 230 can support a plurality of types of communication protocols.

The storage unit 240 can store programs and data. The storage unit 240 is also used as a work area for temporarily storing a processing result of the control unit 250. The storage unit 240 may include an any non-transitory storage medium such as a semiconductor storage medium and a magnetic storage medium. The storage unit 240 may include a plurality of types of storage media. The storage unit 240 may include a combination of a portable storage medium such as a memory card, an optical disk, or a magneto-optical disk and a reading device of the storage medium. The storage unit 240 may include a storage device used as a temporary storage region such as a random access memory (RAM).

The storage unit 240 stores various types of information received via the communication unit 230. The storage unit 240 stores, for example, an operation application 241, the operation information D10, and the like. The operation application 241 is an application used by the operator 900. The operation application 241 provides functions such as generation of the operation information D10 according to the operation by the operator 900, transmission of the operation information D10 to the robot 100, and display of information received from the robot 100.

The control unit 250 is an arithmetic processing device. The arithmetic processing device includes, for example, a central processing unit (CPU), a system-on-a-chip (SoC), a micro control unit (MCU), a field-programmable gate array (FPGA), and a coprocessor, but is not limited thereto. The control unit 250 integrally controls the operation of the operation device 200 to realize various functions.

Specifically, the control unit 250 executes a command included in the program stored in the storage unit 240 while referring to the information stored in the storage unit 240 as necessary. Then, the control unit 250 controls the functional units according to the data and the command, thereby implementing various functions. The functional unit includes, for example, but is not limited to, the display unit 210, the input unit 220, and the communication unit 230.

When the operation application 241 is activated by the operator 900, the control unit 250 receives an operation on the robot 100 via the input unit 220. The control unit 250 generates the operation information D10 indicating the accepted operation to transmit the operation information D10 to the robot 100 via the communication unit 230. The control unit 250 causes the display unit 210 to display the information received from the robot 100, thereby causing the operator 900 to check the states of the robot 100, the object 800, and the like.

The functional configuration example of the operation device 200 according to the present embodiment is described above. Note that the above-described configuration described with reference to FIG. 6 is merely an example, and the functional configuration of the operation device 200 according to the present embodiment is not limited to such an example. The functional configuration of the operation device 200 according to the present embodiment can be flexibly modified according to specifications and operations.

### Configuration Example of Robot According to Embodiment

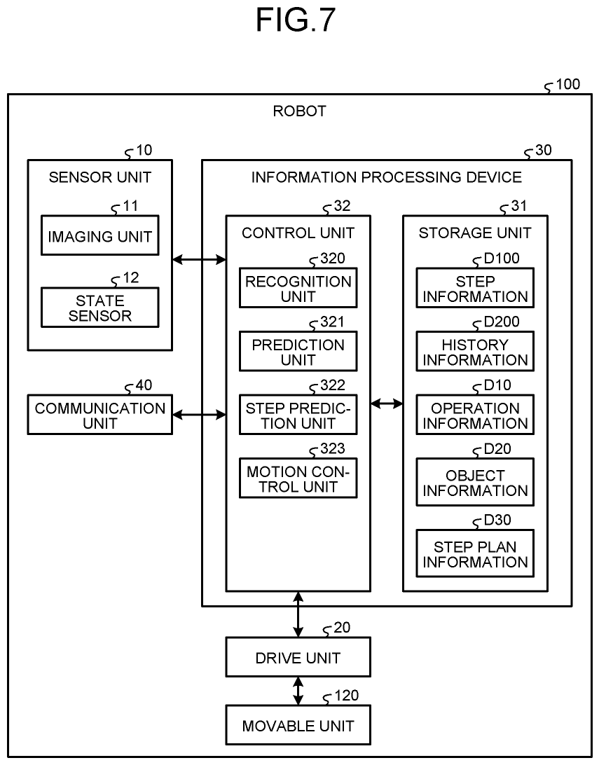

FIG. 7 is a diagram illustrating a configuration example of the robot 100 according to the embodiment. As illustrated in FIG. 7, the robot 100 includes a sensor unit 10, a drive unit 20, an information processing device 30, and a communication unit 40. The information processing device 30 is an example of a control unit of the robot 100 described above. The information processing device 30 is connected to the sensor unit 10, the drive unit 20, and the communication unit 40 so as to be able to exchange data and signals. For example, a case where the information processing device 30 is incorporated in the robot 100 as a unit that controls the motion of the operation unit 120 of the robot 100 based on the operation information D10 will be described, but may be provided outside the robot 100.

The sensor unit 10 includes various sensors and the like that detect information used for processing the robot 100. The sensor unit 10 supplies the detected information to the information processing device 30 and the like. In the present embodiment, the sensor unit 10 includes an imaging unit 11 and a state sensor 12 described above. The sensor unit 10 supplies sensor information indicating an image captured by the imaging unit 11 to the information processing device 30. The state sensor 12 includes, for example, a gyro sensor, an acceleration sensor, a surrounding information detection sensor, and the like. The surrounding information detection sensor detects, for example, an article around the robot 100. The surrounding information detection sensor includes, for example, an ultrasonic sensor, a radar, light detection and ranging, laser imaging detection and ranging (LiDAR), a sonar, and the like. The sensor unit 10 supplies sensor information indicating a detection result of the state sensor 12 to the information processing device 30. The sensor unit 10 supplies sensor information indicating an image obtained by imaging an object to be operated by the robot 100 to the information processing device 30.

For example, the sensor unit 10 may include various sensors for detecting the current position of the robot 100. Specifically, for example, the sensor unit 10 may include a global positioning system (GPS) receiver, a global navigation satellite system (GNSS) receiver that receives a GNSS signal from a GNSS satellite, and the like. For example, the sensor unit 10 may include a microphone that collects sound around the robot 100.

The drive unit 20 includes various devices related to a drive system of the robot 100. The drive unit 20 includes, for example, a driving force generation device or the like for generating a driving force of a plurality of driving motors or the like. The driving motor moves, for example, the operation unit 120 of the robot 100. The drive unit 20 drives each drivable portion of the robot 100. The drive unit 20 includes an actuator that moves the operation unit 120 and the like. The drive unit 20 is electrically connected to the information processing device 30 and is controlled by the information processing device 30. The drive unit 20 drives the actuator to move the operation unit 120 of the robot 100.

For example, in a case where the robot 100 includes a movement mechanism, the drive unit 20 may be configured to drive the movement mechanism. The movement mechanism includes, for example, functions corresponding to a moving form of the robot 100 such as wheels and legs. The drive unit 20 moves the robot 100 by rotating the driving motor based on control information including a command or the like from the information processing device 30, for example.

The communication unit 40 communicates with the operation device 200, an electronic device, a server device, or the like outside the robot 100. The communication unit 40 supplies various types of information received from the operation device 200 or the like to the information processing device 30. The communication unit 40 transmits various types of information instructed by the information processing device 30 to a transmission destination. Note that the communication protocol supported by the communication unit 40 is not particularly limited, and the communication unit 40 can support a plurality of types of communication protocols.

The information processing device 30 has a function of controlling the movement of the operation unit 120 based on the operation information D10 from the operation device 200. The information processing device 30 includes, for example, a dedicated or general-purpose computer. The information processing device 30 may have a function of controlling the moving operation of the robot 100.

The information processing device 30 controls the drive unit 20 to so as to move the operation unit 120 based on a motion command (target position) of the robot 100. The motion command includes, for example, instruction information for moving the operation unit 120 of the robot 100 along the target track, instruction information for holding an object by the operation unit 120 of the robot 100, and the like. The information processing device 30 has a function of changing and re-planning the action plan of the robot 100 so as to assist in the remote operation.

The information processing device 30 includes a storage unit 31 and a control unit 32. Note that the information processing device 30 may include at least one of the sensor unit 10 and the communication unit 40 in the configuration.

The storage unit 31 stores various pieces of data and programs. For example, the storage unit 31 is, for example, a semiconductor memory device such as a random access memory (RAM) and a flash memory, a hard disk, an optical disk, or the like. The storage unit 31 stores, for example, various types of information such as the step information D100, history information D200, the operation information D10 received from the operation device 200, object information D20, and the step plan information D30. The history information D200 includes, for example, information capable of identifying a history of actions of the operation unit 120. The object information D20 includes information capable of identifying the object 800 obtained by sensing the object to be operated by the sensor unit 10. The step plan information D30 includes, for example, information capable of identifying the motion plan of the operation unit 120 in the step.

The control unit 32 includes a recognition unit 320, a prediction unit 321, a step prediction unit 322, and a motion control unit 323. Each functional unit of the recognition unit 320, the prediction unit 321, the step prediction unit 322, and the motion control unit 323 is realized by executing a program stored inside the information processing device 30 using a RAM or the like as a work area by a CPU, a micro processing unit (MPU), or the like. Furthermore, each functional unit may be realized by, for example, an integrated circuit such as an application specific integrated circuit (ASIC) or a field-programmable gate array (FPGA).

The recognition unit 320 captures an object outside of the robot 100 as the object 800 based on the sensor information about the sensor unit 10. For example, the recognition unit 320 searches for the captured object 800 from the model database, and recognizes the object 800 based on the search result. The recognition unit 320 may recognize the acquired object 800 using a machine training program. The recognition unit 320 stores the recognition result in the storage unit 31.

The prediction unit 321 predicts the next action to be executed in the next step by the operation unit 120 in accordance with the remote operation by the operator 900 based on the action executed by the operation unit 120 and the step information D100 capable of identifying the work step. For example, the prediction unit 321 predicts the next action by comparing the previous action with the step information D100. The prediction unit 321 predicts the next action, for example, using an operation history, machine training, or the like of another user who has previously executed the step of the step information D100. The prediction unit 321 predicts the next action to be executed in the next step by the operation unit 120 in accordance with the remote operation and the object 800 to be operated in the relationship between the operation unit 120 and the plurality of objects 800.

The step prediction unit 322 predicts an action and an object 800 in a step based on the next action predicted by the prediction unit 321, the object information D20 to be operated, and the operation information D10. In the step, the step prediction unit 322 executes a prediction at any time or repeatedly while the operation unit 120 is executing the action. The step prediction unit 322 analyzes the positional relationship between the operation unit 120 executing the action and the external object 800, the operation information D10 of the operator 900, and the like, and predicts the action and the object 800 in the step. The step prediction unit 322 has a function of calculating the prediction of the action and the object 800 in the step and the probability (reliability) of the prediction using, for example, a calculation formula, a machine training program, or the like.

The motion control unit 323 plans the step plan information D30 indicating the motion, the track, and the like of the operation unit 120 based on the operation information D10 corresponding to the remote operation. The motion control unit 323 moves the operation unit 120 by controlling the drive unit 20 based on the step plan information D30. The motion control unit 323 controls the motion of the operation unit 120 so as to assist in the remote operation of the operation unit 120 based on the relationship between the next action predicted by the prediction unit 321 or the action predicted by the step prediction unit 322, the operation information D10 about the remote operation, and the object 800 to be operated by the operation unit 120.

In a case where the relationship between the predicted next action, the operation information D10 about the remote operation, and the object 800 to be operated by the operation unit 120 does not satisfy a predetermined condition, the motion control unit 323 controls the operation unit 120 so that motion of the operation unit 120 based on the operation information D10 is obtained. The predetermined condition is, for example, a condition for determining whether to assist in the remote operation. For example, in a case where there is a plurality of predicted next actions or a plurality of objects 800 to be operated for the action, the predetermined condition includes, assisting in the remote operation in a case where the probability of predicting the operation target is equal to or greater than the determination threshold value, and not assisting in the remote operation in a case where the probability is smaller than the determination threshold value.

The motion control unit 323 controls the operation unit 120 so as to assist in the remote operation of the operation unit 120 based on the prediction of the action and the object 800 and the probability of the prediction. The motion control unit 323 has a function of controlling the operation unit 120 so as to change the track of the operation unit 120 based on the remote operation. The motion control unit 323 has a function of controlling the operation unit 120 so as to increase the speed of the operation unit 120 based on the remote operation. In a case where the probability of the predicted action satisfies the automation condition, the motion control unit 323 has a function of controlling the operation unit 120 so that a track corresponding to the action is obtained. The automation condition includes, for example, a condition in which the automation is performed in a case where the prediction probability of the action is greater than or equal to a threshold value, and the automation is not performed in a case where the prediction probability is smaller than the threshold value. The motion control unit 323 has a function of not controlling the operation unit 120 based on the remote operation in a case where the remote operation satisfies the invalidation condition. The invalidation condition includes, for example, a condition in which invalidation is performed in a case where the prediction probability of the action is equal to or less than the determination threshold value, a condition in which invalidation is performed in a case where the safety of the operation information D10 cannot be secured, and the like.

The functional configuration example of the robot 100 according to the present embodiment is described above. Note that the above-described configuration described with reference to FIG. 4 is merely an example, and the functional configuration of the robot 100 according to the present embodiment is not limited to such an example. The functional configuration of the robot 100 according to the present embodiment can be flexibly modified according to specifications and operations.

### Configuration Example of Process P1

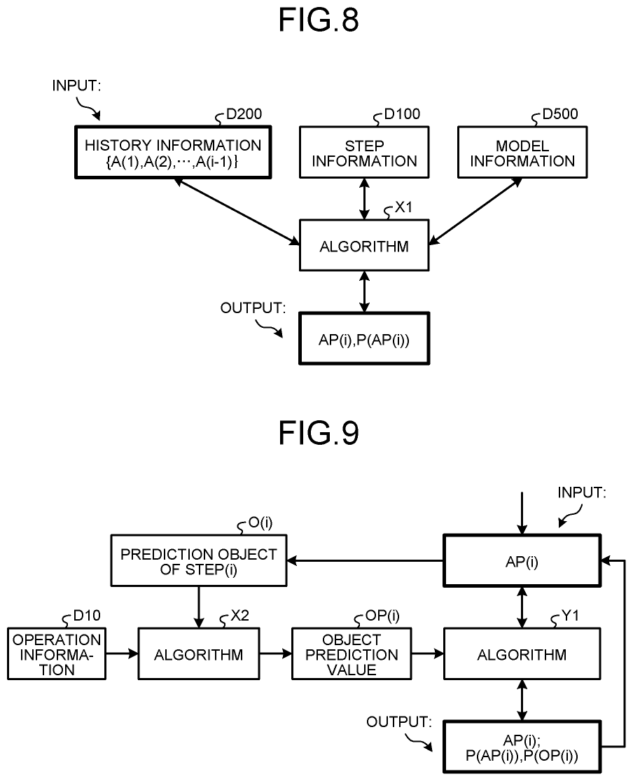

FIG. 8 is a diagram for describing an example of the process P1 of the information processing device 30 according to the embodiment. As illustrated in FIG. 8, an algorithm X1 compares the history information D200 of the actions by the operator 900 up to the step(i−1) with the step (sequence) of the action registered in the recipe of the step information D100 to predict the next action of the operation unit 120 in the step(i). i is an integer corresponding to the step.

The history information D200 includes, for example, information capable of identifying the actions A(1), A(2), . . . , A(i−1), and the like executed by the robot 100 so far. The step information D100 includes information capable of identifying an action, a sequence of the related object 800, and the like. Model information D500 includes information capable of identifying a sequence of model actions in a similar step (recipe), the same step, or the like, and is constructed in a database or the like.

The algorithm X1 is an algorithm such as machine training, and a neural network, a recurrent neural network, or the like can be used. The algorithm X1 outputs the prediction value AP(i) of the action in the step(i) and the probability P(AP(i)) of the predicted next action. In a case where there is a plurality of possibilities (candidates) of the next action, the algorithm X1 outputs the prediction value AP(i) related to each action and the probability P(AP(i)) of the predicted action. The prediction value AP(i) is, for example, a value capable of identifying the predicted next action, and a value corresponding to the action in the step is set. The information processing device 30 inputs the action history information D200, the step information D100, and the model information D500 to the algorithm X1 to obtain the prediction value AP(i) predicted by the algorithm X1 and the probability P(AP(i)) of the predicted action as outputs.

### Configuration Example of Process P2

FIG. 9 is a diagram for describing an example of the process P2 of the information processing device 30 according to the embodiment. As illustrated in FIG. 9, the information processing device 30 compares the prediction value AP(i) of the next action which is the output of the process P1 with the step information D100 to obtain the prediction object O(i) in the step(i) corresponding to the predicted action. The prediction object O(i) is an object, in the step(i), predicted from the step information D100. i is an integer corresponding to the step.

The information processing device 30 inputs the prediction object O(i) in the step(i) and sensor information D40 related to the operator 900 and the object 800 to an algorithm X2 to obtain the object prediction value OP(i) when predicting the object 800 to be currently operated. In this case, the sensor information D40 includes position information about the object 800 and information such as the posture, the motion direction, and the line-of-sight direction of the operator 900, and is configured to be able to predict the object 800. The object prediction value OP(i) is, for example, a value capable of identifying the object 800 to be operated by with respect to next action in the step.

An algorithm X2 compares the prediction object O(i) in the step(i) with the sensor information D40 related to the operator 900 and the object 800 to predict the object prediction value OP(i). The algorithm X2 is an algorithm such as machine training, and a neural network, a recurrent neural network, or the like can be used. The algorithm X2 outputs the object prediction value OP(i) of the predicted object 800 to be currently operated based on the prediction object O(i) and the sensor information D40 that were input.

The information processing device 30 inputs the object prediction value OP(i) output by the algorithm X2 and the prediction value AP(i) that is the output of the process P1 to the algorithm Y to obtain the output of the probability P(AP(i)) of the prediction value AP(i) and the probability P(OP(i)) of the object prediction value OP(i). The algorithm Y outputs the probability P(AP(i)) of the prediction value AP(i) and the probability P(OP(i)) of the object prediction value OP(i) based on a prediction model machine trained on the relationship between the object prediction value OP(i) and the prediction value AP(i) that is the output of the process P1. When receiving the plurality of object prediction values OP(i), the algorithm Y outputs probabilities P(OP(i)) corresponding to the respective object prediction values OP(i).

### Configuration Example of Process P3

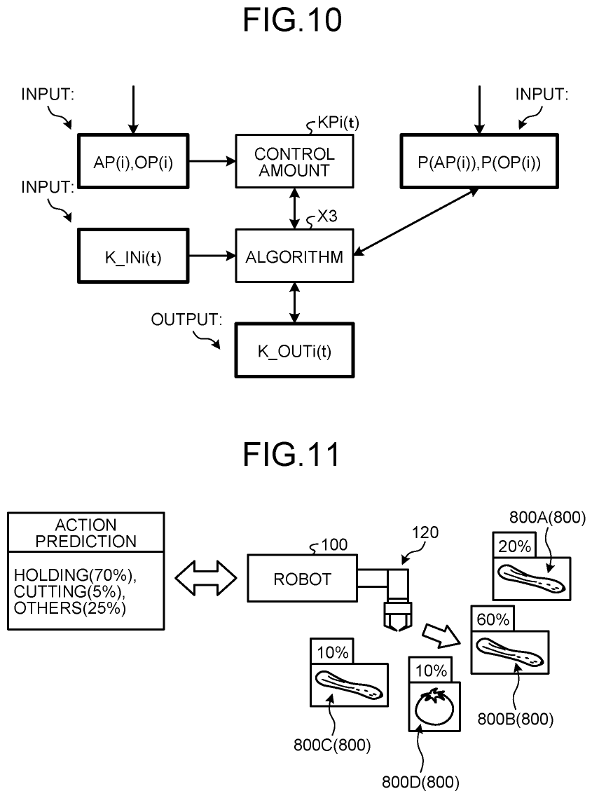

FIG. 10 is a diagram for describing an example of the process P3 of the information processing device 30 according to the embodiment. As illustrated in FIG. 10, an algorithm X3 is used for each control cycle during the operation by the operator 900 as in the process P2. The algorithm X3 uses the prediction values of the action and the object 800 obtained in the process P2 to obtain a control amount, a parameter, and the like that assist in the control of the operation unit 120. The control amount includes, for example, parameters related to control such as a track and a speed of the operation unit 120.

The information processing device 30 calculates a control amount KPi(t) of the operation unit 120 based on the prediction value AP(i) of the action calculated in the process P2 and its probability P(AP(i)). i is an integer corresponding to the step. t is an integer capable of identifying a control cycle, time, and the like. The information processing device 30 inputs the calculated control amount KPi(t), the operation amount K_INi(t) based on the operation information D10 of the operator 900, and the probability P(AP(i)) and the probability P(OP(i)) of the process P3 to the algorithm X3.

The algorithm X3 is an algorithm such as machine training, changes the operation by the operator 900 based on the input control amount KPi(t), the operation amount K_INi(t), and the probability P(AP(i)) and the probability P(OP(i)) to output a control amount K_OUTi(t) for assisting the operator 900 in the operation. The information processing device 30 inputs the control amount KPi(t), the operation amount K_INi(t), the probability P(AP(i)), and the probability P(OP(i)) to the algorithm X3 to obtain the control amount K_OUTi(t) output by the algorithm X3. The information processing device 30 changes the operation (input) by the operator 900 based on the control amount K_OUTi(t) output by the algorithm X3, and controls the motion of the operation unit 120 so as to assist in the operation.

### Example of Control Assist of Information Processing Device

### Change in Track of Operation Unit

The information processing device 30 provides a function of assisting in control for changing the track of the operation unit 120. The information processing device 30 assists in control using a conditional expression C1 of probability P(AP(i))>P_traj(thresh). P_traj(thresh) is a threshold value (lower limit value) of the probability for changing the track. That is, the conditional expression C1 is a condition for determining whether the probability of the predicted action is larger than the threshold value of the probability for performing the track change. For example, the conditional expression C1 can set a condition in which the track is changed when the probability P(AP(i))>50%.

When the probability P(AP(i)) of the predicted action exceeds the threshold value of P_traj(thresh), the information processing device 30 performs a linear combination of a track automatically generated according to the prediction probability of the corresponding object 800 and a track input by the operator 900. The information processing device 30 calculates a track T_OUT(t) of the operation unit 120 (output) using the following Expression (1). TPi(t) is a track generated based on the action and the object 800 predicted. T_INi(t) is a track by the input by the operator 900. P(OP(i)) is the probability of the predicted object 800.

$$T\_OUT ( t ) = P ( OP ( i ) ) * TPi ( t ) + [ 1 - P ( OP ( i ) ) ] * T\_INi ( t ) \qquad Expression ( 1 )$$

In the present embodiment, the information processing device 30 increases the weight of the automatically generated track as the probability P(OP(i)), which is the prediction probability of the object, approaches 100%, and performs automatic control when the probability P(OP(i)) reaches 100%.

FIG. 11 is a diagram for describing an example of the track change in the control assist according to the embodiment. In the example illustrated in FIG. 11, 50% for P_traj(thresh) of the conditional expression C1 is set as the lower limit value. The information processing device 30 predicts, as the action prediction, a probability P(AP(i)) of 70% for “holding”, 5% for “cutting”, and 25% for others. The information processing device 30 predicts that the probability P(OP(i)) of the object 800 is 20% for the object 800A, 60% for the object 800B, 10% for the object 800C, and 10% for the object 800D. In this case, the information processing device 30 automatically generates an optimal track for holding the cucumber object 800B, and substitutes the probability (60%) into Expression (1). In the information processing device 30, the weight of the automatically generated track is 0.6 and the weight of the operator's operation is 0.4 according to the track T_OUT(t)=0.6*TPi(t)+0.4*T_INi(t). As a result, the information processing device 30 assists the operator 900 in the operation by controlling the operation unit 120 so that the calculated track T_OUT(t) is obtained.

### Increase in Speed of Operation Unit

The information processing device 30 provides a function of assisting in control for increasing the speed of the operation unit 120. The information processing device 30 assists in control using a conditional expression C2 of probability P(AP(i))>P_vel(thresh). P_vel(thresh) is a threshold value (lower limit value) of the probability for performing the speed increase. That is, the conditional expression C2 is a condition for determining whether the probability of the predicted action is larger than the threshold value of the probability for performing the speed increase. For example, in a case where the conditional expression C2 indicates that the probability P(AP(i))>80%, and the probability P(OP(i)) of the object 800 is 50%, the information processing device 30 makes the speed of the operation unit 120 1.5 times the input by the operator 900.

When the probability P(AP(i)) of the predicted action exceeds the threshold value of P_vel(thresh), the information processing device 30 increases the speed of the operation unit 120 to a speed higher than the speed input by the operator 900 according to the prediction probability of the corresponding object 800. For example, the information processing device 30 increases the output speed of the operation unit 120 as the prediction probability of the object 800 approaches 100%, and sets the upper limit value to a value twice the speed input by the operator 900. In the present embodiment, the information processing device 30 is configured such that the threshold value for increasing the speed is set higher than the threshold value for changing the track, and the speed of the operation unit 120 increases as the prediction of the action and the object 800 is more reliable.

The information processing device 30 calculates the speed dT_OUTi(t)/dt of the operation unit 120 using the following Expression (2). T_INi(t) is a track by the input by the operator 900. T_OUTi(t) is a track of the operation unit 120.

$$dT\_OUTi ( t ) / dt = [ 1 + P ( OP ( i ) ) ] * dT - INi ( t ) / dt \qquad Expression ( 2 )$$

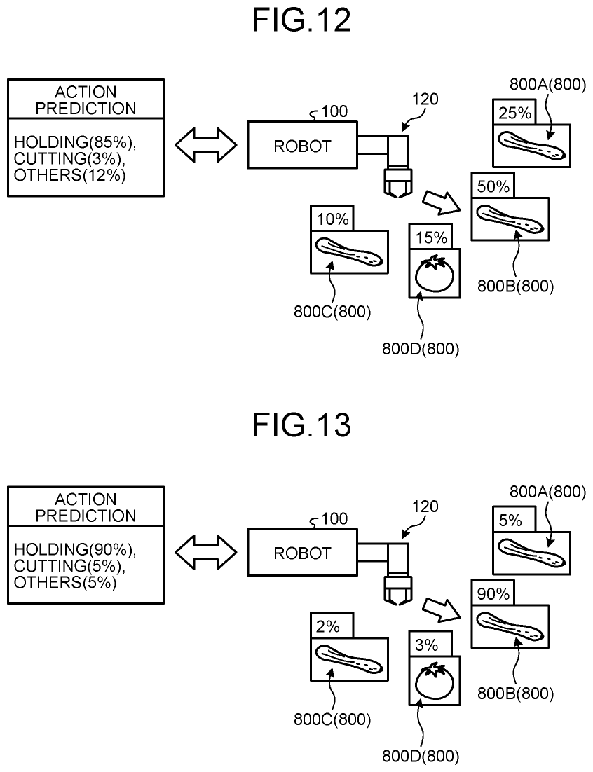

FIG. 12 is a diagram for describing an example of the speed increase in the control assist according to the embodiment. In the example illustrated in FIG. 12, 80% for P_vel(thresh) of the conditional expression C2 is set as the lower limit value. The information processing device 30 predicts, as the action prediction, a probability P(AP(i)) of 85% for “holding”, 3% for “cutting”, and 12% for others. The information processing device 30 predicts that the probability P(OP(i)) of the object 800 is 25% for the object 800A, 50% for the object 800B, 10% for the object 800C, and 15% for the object 800D. In this case, the information processing device 30 sets the object 800B having the highest probability as the object 800 to be operated. The information processing device 30 calculates the speed by substituting the probability (50%) of the object 800B into Expression (2), thereby calculating the speed 1.5 times the speed input by the operator 900. As a result, the information processing device 30 assists the operator 900 in the operation by controlling the operation unit 120 so that the calculated speed is obtained.

### Automation of Action of Operation Unit

The information processing device 30 provides a function of assisting in control for automating the action of the operation unit 120. The information processing device 30 assists in control using a conditional expression C3 of probability P(AP(i))>P_action(thresh), probability P(OP(i))>P_object(thresh):track T_OUT(t)=track T_P(t). P_action(thresh) is a threshold value (lower limit value) of the probability of the action for automating the action. P_object(thresh) is a threshold value (lower limit value) of the probability of the object for automating the action. The track T_OUT(t) is an actual track of the operation unit 120. The track T_P(t) is the predicted object. It is a track automatically generated based on the object.

When the prediction probabilities of the action and the object 800 predicted exceed the respective threshold values, the information processing device 30 automatically generates a track optimal for the combination and controls the operation unit 120 using the track. That is, in order that the information processing device 30 performs automatic control in which the weight of the operation by the operator 900 is 0 it is required to predict the action and the object 800 with high probability. Therefore, the information processing device 30 is required to set the threshold values of the probability P(AP(i)) of the action and the probability P(OP(i)) of the object 800 to be higher than the threshold value of the track change and the threshold value of the speed increase described above. Furthermore, the information processing device 30 can use a command such as track control or a special command such as “cut”, “open”, “gripping”, or the like as the automatically controlled action.

FIG. 13 is a diagram for describing an example of the automation in the control assist according to the embodiment. In the example illustrated in FIG. 13, 90% for P_action(thresh) and P_object(thresh) of the conditional expression C3 is set as a lower limit value. The information processing device 30 predicts, as the action prediction, a probability P(AP(i)) of 90% for “holding”, 5% for “cutting”, and 5% others. The information processing device 30 predicts that the probability P(OP(i)) of the object 800 is 5% for the object 800A, 90% for the object 800B, 2% for the object 800C, and 3% for the object 800D. In this case, the information processing device 30 sets the action of “gripping” and the object 800B of “cucumber” whose probability exceeds 90% as targets to be automatically controlled. The information processing device 30 controls the motion of the operation unit 120 so as to grip the object 800B. As a result, the information processing device 30 assists the operator 900 in the operation by not requiring the operation by the operator 900 for gripping.

### Invalidation of Input by Operator

The information processing device 30 provides a function of assisting in control for invalidating the input by the operator 900 to the operation unit 120. For example, operator 900 may perform an erroneous operation. In a case where the probability of the predicted action is lower than the determination threshold value and appropriate prediction is impossible, the information processing device 30 invalidates the input by the operator 900.

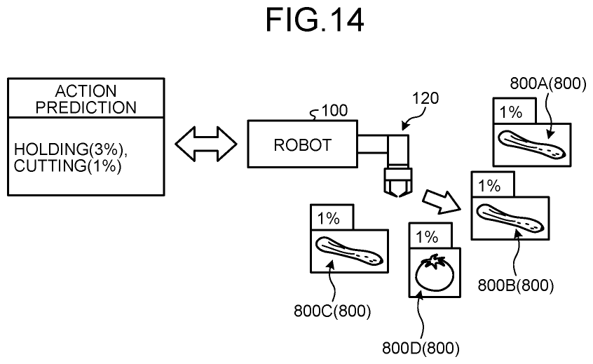

FIG. 14 is a diagram for describing an example of the input invalidation in the control assist according to the embodiment. In the example illustrated in FIG. 14, the information processing device 30 predicts, as the action prediction, a probability P(AP(i)) of 3% for “holding” and 1% for “cutting”. The information processing device 30 predicts that the probability P(OP(i)) of the object 800 is 1% for the object 800A, 1% for the object 800B, 1% for the object 800C, and 1% for the object 800D. In this case, the information processing device 30 invalidates the input by the operator 900 until the prediction probability of the action exceeds 5%. The information processing device 30 can use the input invalidation function not only to perform an efficient operation without performing an operation having low relevance to the recipe, the procedure manual, and the like of the step information D100 but also to ensure safety and the like. As a result, the information processing device 30 does not receive an erroneous operation by the operator 900, and thus assists in the operation such that the operation unit 120 operates normally.

### Process Control of Information Processing Device

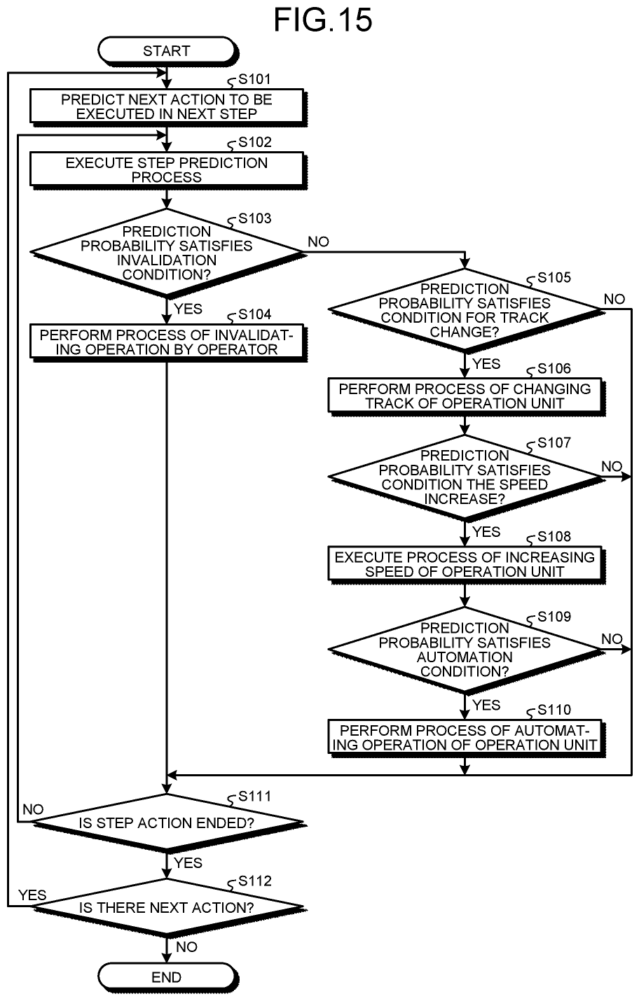

FIG. 15 is a flowchart illustrating an example of a processing procedure related to process control of the information processing device 30. The processing procedure illustrated in FIG. 15 is realized by the control unit 32 of the information processing device 30 executing a program. The processing procedure illustrated in FIG. 15 corresponds to each step described above, and is executed in response to the end of the action of the previous step.

As illustrated in FIG. 15, the control unit 32 of the information processing device 30 predicts a next action to be executed in the next step (step S101). For example, the control unit 32 executes the step of the process P1 described above and compares the action history information D200 with the action step indicated by the step information D100 to predict the next action by the operation unit 120 in the next step. For example, the control unit 32 obtains a prediction value AP(i) of the next action and a probability P(AP(i)) of the predicted next action using the above-described algorithm X1 or the like. After storing the prediction result in the storage unit 31, the control unit 32 advances the process to step S102.

The control unit 32 executes a step prediction process (step S102). The step prediction process includes, for example, a process related to the process P2 described above and a process of controlling the motion of the operation unit 120. For example, the control unit 32 executes the step prediction process and obtains the object prediction value OP(i) when predicting the object 800 to be currently operated using the above-described algorithm X2 or the like. For example, the control unit 32 plans the step plan information D30 based on the operation information D10 corresponding to the remote operation, and controls the drive unit 20 based on the step plan information D30 to move the operation unit 120. When the process in step S102 ends, the control unit 32 advances the process to step S103.

The control unit 32 determines whether the prediction probability satisfies the invalidation condition (step S103). For example, in a case where the prediction probability of the action predicted in step S102 is smaller than the invalidation threshold value (5%), the control unit 32 determines that the prediction probability satisfies the invalidation condition. In a case where it is determined that the prediction probability satisfies the invalidation condition (Yes in step S103), the control unit 32 advances the process to step S104.

The control unit 32 performs the process of invalidating the operation by the operator 900 (step S104). For example, the control unit 32 invalidates the operation information D10 from the operation device 200 or temporarily stops the operation unit 120 being operated. When the process in step S104 ends, the control unit 32 advances the process to step S111 described later.

In addition, in a case where it is determined that the prediction probability does not satisfy the invalidation condition (No in step S103), the control unit 32 advances the process to step S105. The control unit 32 determines whether the prediction probability satisfies the condition for the track change (step S105). For example, in a case where the conditional expression C1 of the probability P(AP(i))>P_traj(thresh) is satisfied, the control unit 32 determines that the prediction probability satisfies the condition for the track change. In a case where it is determined that the prediction probability does not satisfy the condition for the track change (No in step S105), the control unit 32 advances the process to step S111 described later. In a case where it is determined that the prediction probability satisfies the condition for the track change (Yes in step S105), the control unit 32 advances the process to step S106.

The control unit 32 performs the process of changing the track of the operation unit 120 (step S106). For example, the control unit 32 assists the operator 900 in the operation by changing the track of the operation unit 120 by performing a linear combination of the track automatically generated according to the prediction probability of the object 800 and the track input by the operator 900. When the process in step S106 ends, the control unit 32 advances the process to step S107.

The control unit 32 determines whether the prediction probability satisfies the condition for the speed increase (step S107). For example, in a case where the conditional expression C2 of the probability P(AP(i))>P_vel(thresh) is satisfied, the control unit 32 determines that the prediction probability satisfies the condition for the speed increase. In a case where it is determined that the prediction probability does not satisfy the condition for the speed increase (No in step S107), the control unit 32 advances the process to step S111 described later. In addition, in a case where it is determined that the prediction probability satisfies the condition for the speed increase (Yes in step S107), the control unit 32 advances the process to step S108.

The control unit 32 performs the process of changing the speed of the operation unit 120 (step S108). For example, the control unit 32 assists the operator 900 in the operation by increasing the speed of the operation unit 120 by increasing the output speed of the operation unit 120 as the prediction probability of the object 800 approaches 100%. When the process in step S108 ends, the control unit 32 advances the process to step S109.

The control unit 32 determines whether the prediction probability satisfies the automation condition (step S109). For example, the control unit 32 determines that the prediction probability satisfies the automation condition in a case where the conditional expression C3 of the probability P(AP(i))>P_action(thresh) and probability P(OP(i))>P_object(thresh):track T_OUT(t)=track T_P(t) described above is satisfied. In a case where it is determined that the prediction probability does not satisfy the automation condition (No in step S109), the control unit 32 advances the process to step S111 described later. In a case where it is determined that the prediction probability satisfies the automation condition (Yes in step S109), the control unit 32 advances the process to step S110.

The control unit 32 performs the process of automating the operation of the operation unit 120 (step S110). For example, the control unit 32 assists the operator 900 in the operation by generating a track optimum for the predicted action and controlling the operation unit 120 so that the track is obtained. When the process in step S110 ends, the control unit 32 advances the process to step S111.

The control unit 32 determines whether the action in the step has ended (step S111). For example, in a case where the motion of the operation unit 120 indicated by the step plan information D30 ends, the control unit 32 determines that the action in the step ends. In a case where it is determined that the action in the step has not ended (No in step S111), the control unit 32 returns the process to step S102 and continues the process. In a case where it is determined that the action in the step has ended (Yes in step S111), the control unit 32 advances the process to step S112.

The control unit 32 determines whether there is a next action (step S112). For example, in a case where the step plan information D30 indicates the next action in the step, the control unit 32 determines that there is the next action. In a case where it is determined that there is the next action (Yes in step S112), the control unit 32 returns the process to step S101 described above and continues the process. In a case where it is determined that there is no next action (No in step S112), the control unit 32 ends the processing procedure illustrated in FIG. 15.

In the processing procedure illustrated in FIG. 15, the process of step S101 corresponds to the process of the process P1 described above. The process of step S102 corresponds to the process of the process P2 described above. A series of processes from step S103 to step S111 corresponds to the process of the process P3 described above.

As described above, the information processing device 30 can compare the prediction probabilities of the action of the operation unit 120 and the object 800 in the step with the conditions for executing a plurality of assists and execute the assist satisfying the conditions. As a result, the information processing device 30 predicts the next action in the next step based on the step information D100, thereby executing the assist suitable for the relationship between the next action, the operation information D10, and the object 800 to be operated. As a result, the information processing device 30 can improve the operability of the operation unit 120 by the remote operation by the operator 900 and simplify the remote operation by the operator 900 by improving the efficiency of the motion of the operation unit 120.

### Precondition of Action

The information processing device 30 according to the embodiment can use a precondition for enabling a plurality of actions to be executed. The precondition includes, for example, a condition combining completion information about another action, a state of the robot 100, a surrounding state/situation, and the like. The completion information includes, for example, information such as a type of action and whether the action has been completed. The state of the robot 100 includes, for example, information such as an equipped tool, whether the object 800 is held, and the held object 800 (cooking utensil, foodstuff, and the like). The surrounding state/situation includes, for example, information such as whether there is a human around the robot 100, the state of the object 800 (foodstuff or the like), the state of tableware, and the like.

The information processing device 30 can provide a function of checking a satisfied condition and excluding an inexecutable action from the candidates of the next action in advance when predicting the next action in the above-described step. Furthermore, the information processing device 30 can provide a function of excluding the object 800 corresponding only to the inexecutable action from the object to be predicted in the step. As a result, the information processing device 30 can construct a more accurate and faster prediction algorithm.

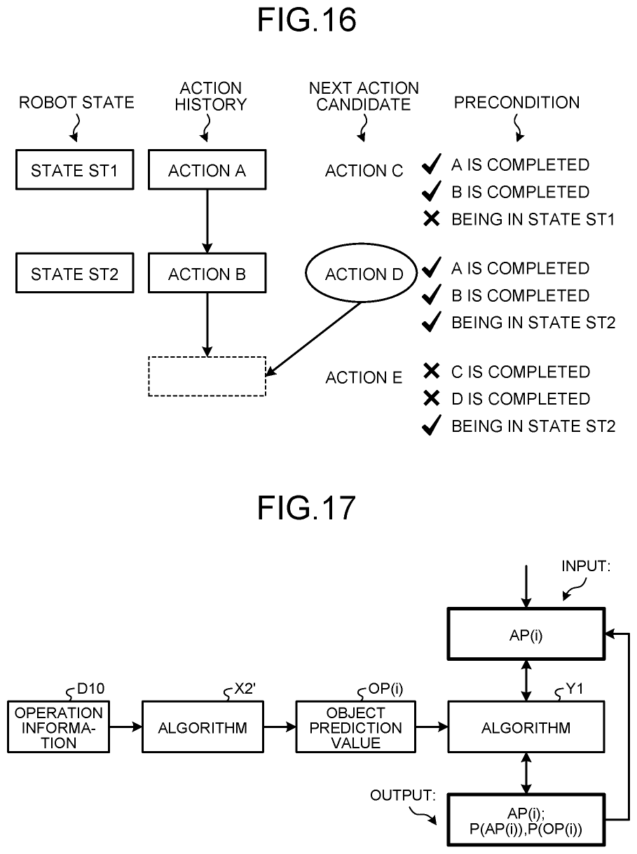

FIG. 16 is a diagram for describing an example of an action prediction in consideration of the precondition of the information processing device 30. In the example illustrated in FIG. 16, the information processing device 30 predicts a next action when an action A is executed in a state ST of the robot 100 and then an action B executed in a state ST2 is completed. In this case, the information processing device 30 recognizes that the robot 100 is in the state ST2, checks the respective preconditions with an action C, an action D, and an action E as the next action as candidates.

The preconditions for the action C are that the action A is completed, that the action B is completed, and that the state of the robot 100 is in the state ST1. The preconditions for the action D are that the action A is completed, that the action B is completed, and that the state of the robot 100 is in the state ST2. The preconditions for the action E are that the action C is completed, that the action D is completed, and that the state of the robot 100 is in the state ST2.

Since all the preconditions for the action D are satisfied and not all the preconditions for the action C and the action E are satisfied, the information processing device 30 excludes the action C and the action E from the candidates of the next action. The information processing device 30 predicts an action D that satisfies all the preconditions as the next action. As a result, the information processing device 30 can improve the accuracy of predicting the next action.

### Modification of Process P2 of Information Processing Device

The case where the prediction object O(i) in the step(i) is used to obtain the object prediction value OP(i) in the process P2 illustrated in FIG. 9 described above is described, but the present invention is not limited thereto.

FIG. 17 is a diagram for describing a modification of the process P2 of the information processing device 30 according to the embodiment. As illustrated in FIG. 17, the process P2 includes inputting only the sensor information D40 to the algorithm X2′ without using the prediction object O(i) in the step(i) to obtain the object prediction value OP(i) when predicting the object 800 to be currently operated. That is, the algorithm X2′ is changed to an algorithm for predicting the object prediction value OP(i) based on the sensor information D40 related to the object 800. The information processing device 30 inputs the object prediction value OP(i) output by the algorithm X2′ and the prediction value AP(i) that is the output of the process P1 to the algorithm Y to obtain the output of the probability P(AP(i)) of the prediction value AP(i) and the probability P(OP(i)) of the object prediction value OP(i).

### Modification of Process Control of Information Processing Device

In the processing procedure illustrated in FIG. 15 described above, the processing procedure in which the control unit 32 is capable of executing a plurality of operation assists in parallel is described, but the present invention is not limited thereto. The processing procedure illustrated in FIG. 15 can be changed such that the plurality of assists is not executed in parallel, but the number of types of assists to be executed simultaneously is set to one at maximum.

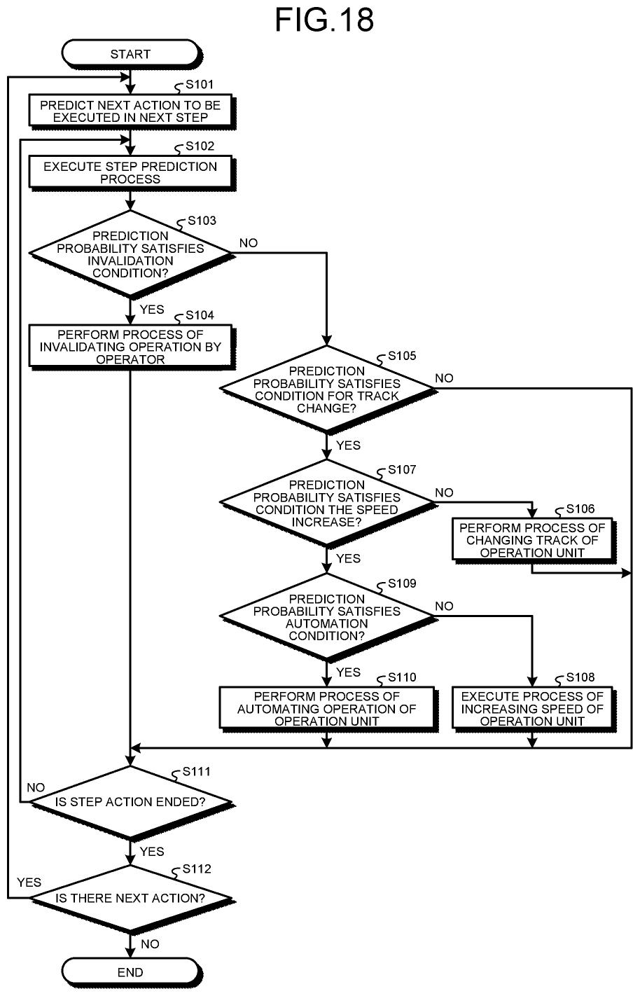

FIG. 18 is a flowchart illustrating a modification of a processing procedure related to process control of the information processing device 30. The processing procedure illustrated in FIG. 18 is realized by the control unit 32 of the information processing device 30 executing a program. In the processing procedure illustrated in FIG. 18, substantially the same steps as those illustrated in FIG. 15 are denoted by the same reference numerals. In the processing procedure illustrated in FIG. 18, since the processing from step S101 to step S104 is the same as the processing from step S101 to step S104 in FIG. 15, the description thereof is omitted.

As illustrated in FIG. 18, the control unit 32 of the information processing device 30 determines whether the prediction probability satisfies the condition for the track change (step S105). In a case where it is determined that the prediction probability does not satisfy the condition for the track change (No in step S105), the control unit 32 advances the process to step S111 described later. In a case where it is determined that the prediction probability satisfies the condition for the track change (Yes in step S105), the control unit 32 advances the process to step S107.

The control unit 32 determines whether the prediction probability satisfies the condition for the speed increase (step S107). In a case where it is determined that the prediction probability does not satisfy the condition for the speed increase (No in step S107), the control unit 32 advances the process to step S106 described later. The control unit 32 performs the process of changing the track of the operation unit 120 (step S106). When the process of changing the track in step S106 ends, the control unit 32 advances the process to step S111 described later.

In addition, in a case where it is determined that the prediction probability satisfies the condition for the speed increase (Yes in step S107), the control unit 32 advances the process to step S109. The control unit 32 determines whether the prediction probability satisfies the automation condition (step S109). In a case where it is determined that the prediction probability does not satisfy the automation condition (No in step S109), the control unit 32 advances the process to step S108. The control unit 32 performs the process of changing the speed of the operation unit 120 (step S108). When the process of changing the speed in step S108 ends, the control unit 32 advances the process to step S111 described later.

In a case where it is determined that the prediction probability satisfies the automation condition (Yes in step S109), the control unit 32 advances the process to step S110. The control unit 32 performs the process of automating the operation of the operation unit 120 (step S110). When the process of automating the operation in step S110 ends, the control unit 32 advances the process to step S111.

The control unit 32 determines whether the action in the step has ended (step S111). In a case where it is determined that the action in the step has not ended (No in step S111), the control unit 32 returns the process to step S102 and continues the process. In a case where it is determined that the action in the step has ended (Yes in step S111), the control unit 32 advances the process to step S112.

The control unit 32 determines whether there is a next action (step S112). In a case where it is determined that there is the next action (Yes in step S112), the control unit 32 returns the process to step S101 described above and continues the process. In a case where it is determined that there is no next action (No in step S112), the control unit 32 ends the processing procedure illustrated in FIG. 18.

The information processing device 30 compares the prediction probabilities of the action of the operation unit 120 and the object 800 with a conditional expression for executing each assist, and executes one assist without executing a plurality of assists in parallel in a case where the conditional expression is satisfied. As a result, the information processing device 30 can execute an efficient assist by executing the only assist suitable for the remote operation.

In the present embodiment described above, the information processing device 30 can further change the processing procedure illustrated in FIGS. 15 and 18. For example, the information processing device 30 may be configured to selectively control execution of a plurality of assists using a switch, setting data, or the like that can set whether to execute the assist. For example, the information processing device 30 can first determine whether the condition of the assist is satisfied, determine whether the assist is valid in a case where it is determined that the condition is satisfied, and change the processing procedure to a processing procedure for executing the assist process in a case where it is determined that the assist is valid. For example, the information processing device 30 can first determine whether the assist is valid, determine whether a condition of the assist is satisfied in a case where it is determined that the assist is valid, and change the processing procedure to a processing procedure for executing the assist process in a case where it is determined that the condition is satisfied.

For example, the remote operation system 1 can add, to the information processing device 30, a configuration in which the operator 900 can set whether the assist is valid or invalid for each of a plurality of assists, and can control the assist in the remote operation based on the setting. It is assumed that the information processing device 30 stores setting data in which whether the assist is valid or invalid is set in the storage unit 31.

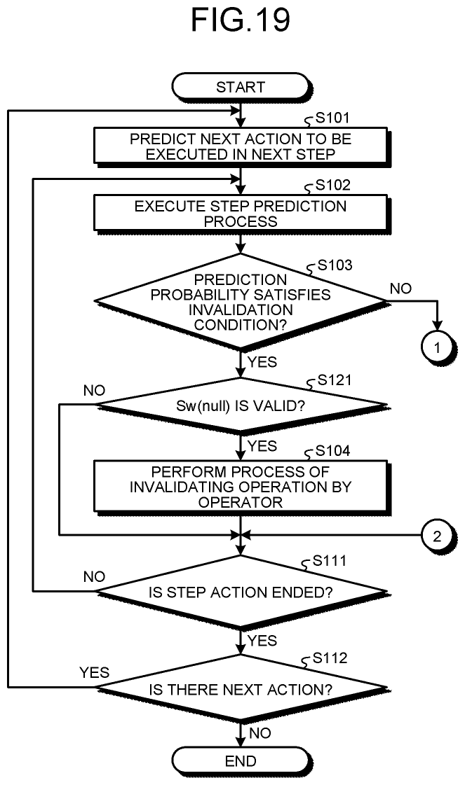

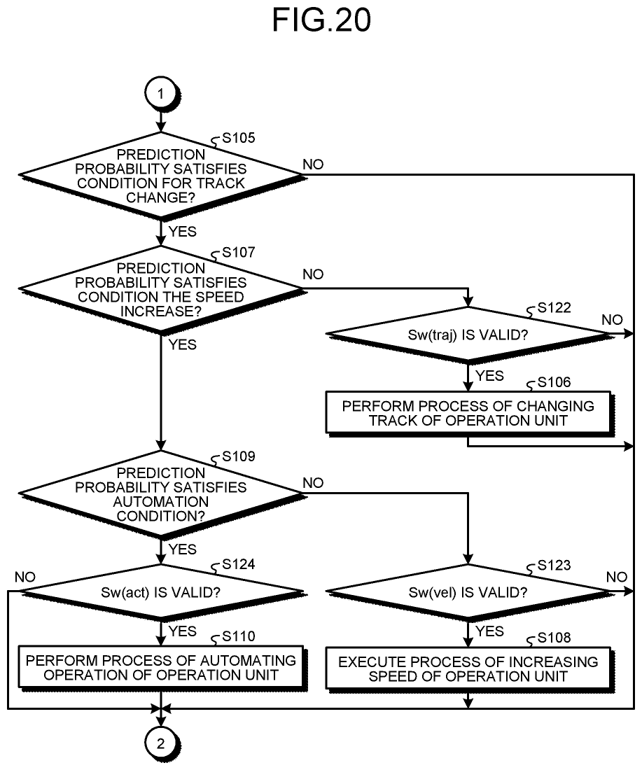

FIG. 19 is a flowchart illustrating another modification of a processing procedure related to process control of the information processing device 30. FIG. 20 is a flowchart illustrating the continuation of the processing procedure illustrated in FIG. 19. The processing procedure illustrated in FIGS. 19 and 20 is realized by the control unit 32 of the information processing device 30 executing a program. In the processing procedures illustrated in FIGS. 19 and 20, substantially the same steps as those illustrated in FIGS. 15 and 18 are denoted by the same reference numerals.

As illustrated in FIG. 19, the control unit 32 of the information processing device 30 predicts a next action to be executed in the next step (step S101). The control unit 32 executes a step prediction process (step S102). The control unit 32 determines whether the prediction probability satisfies the invalidation condition (step S103). In a case where it is determined that the prediction probability satisfies the invalidation condition (Yes in step S103), the control unit 32 advances the process to step S121.

The control unit 32 determines whether a switch Sw (null) is valid (step S121). The switch Sw (null) is set to be enabled in a case where the input by the operator 900 is invalidated, and is set to be disabled in a case where the input is not invalidated. In a case where it is determined that the switch Sw (null) is not valid, that is, is invalid (No in step S121), the control unit 32 advances the process to step S111. In addition, in a case where it is determined that the switch Sw (null) is valid (Yes in step S121), the control unit 32 advances the process to step S104. The control unit 32 performs the process of invalidating the operation by the operator 900 (step S104). When the process in step S104 ends, the control unit 32 advances the process to step S111.

In addition, in a case where it is determined that the prediction probability does not satisfy the invalidation condition (No in step S103), the control unit 32 advances the process to step S105 illustrated in FIG. 20.

As illustrated in FIG. 20, the control unit 32 determines whether the prediction probability satisfies the condition for the track change (step S105). In a case where it is determined that the prediction probability does not satisfy the condition for the track change (No in step S105), the control unit 32 advances the process to step S111 in FIG. 19 described later. In a case where it is determined that the prediction probability satisfies the condition for the track change (Yes in step S105), the control unit 32 advances the process to step S107.

The control unit 32 determines whether the prediction probability satisfies the condition for the speed increase (step S107). In a case where it is determined that the prediction probability does not satisfy the condition for the speed increase (No in step S107), the control unit 32 advances the process to step S122.

The control unit 32 determines whether a switch Sw (traj) is valid (step S122). The switch Sw (traj) is set to be enabled in a case where the assist of the track change is validated, and is set to be disabled in a case where the assist is invalidated. In a case where it is determined that the switch Sw (traj) is not valid, that is, invalid (No in step S122), the control unit 32 advances the process to step S111 in FIG. 19 described later. In addition, in a case where it is determined that the switch Sw (traj) is valid (Yes in step S122), the control unit 32 advances the process to step S106. The control unit 32 performs the process of changing the track of the operation unit 120 (step S106). When the process of changing the track in step S106 ends, the control unit 32 advances the process to step S111 in FIG. 19 described later.

In addition, in a case where it is determined that the prediction probability satisfies the condition for the speed increase (Yes in step S107), the control unit 32 advances the process to step S109. The control unit 32 determines whether the prediction probability satisfies the automation condition (step S109). In a case where it is determined that the prediction probability does not satisfy the automation condition (No in step S109), the control unit 32 advances the process to step S123.

The control unit 32 determines whether a switch Sw (vel) is valid (step S123). The switch Sw (vel) is set to be enabled in a case where the assist of the speed increase is validated, and is set to be disabled in a case where the assist of the speed increase is invalidated. In a case where it is determined that the switch Sw (vel) is not valid, that is, invalid (No in step S123), the control unit 32 advances the process to step S111 in FIG. 19 described later. In addition, in a case where it is determined that the switch Sw (vel) is valid (Yes in step S123), the control unit 32 advances the process to step S108. The control unit 32 performs the process of changing the speed of the operation unit 120 (step S108). When the process of changing the speed in step S108 ends, the control unit 32 advances the process to step S111 in FIG. 19 described later.

In a case where it is determined that the prediction probability satisfies the automation condition (Yes in step S109), the control unit 32 advances the process to step S124.

The control unit 32 determines whether a switch Sw (act) is enabled (step S124). The switch Sw (act) is set to be enabled in a case where the assist of the operation automation is validated, and is set to be disabled in a case where the assist is invalidated. In a case where it is determined that the switch Sw (act) is not valid, that is, is invalid (No in step S124), the control unit 32 advances the process to step S111 in FIG. 19 described later. In a case where it is determined that the switch Sw (act) is valid (Yes in step S124), the control unit 32 advances the process to step S110. The control unit 32 performs the process of automating the operation of the operation unit 120 (step S110). When the process of automating the operation in step S110 ends, the control unit 32 advances the process to step S111 in FIG. 19.

Returning to FIG. 19, the control unit 32 determines whether the action in the step has ended (step S111). In a case where it is determined that the action in the step has not ended (No in step S111), the control unit 32 returns the process to step S102 and continues the process. In a case where it is determined that the action in the step has ended (Yes in step S111), the control unit 32 advances the process to step S112.

The control unit 32 determines whether there is a next action (step S112). In a case where it is determined that there is the next action (Yes in step S112), the control unit 32 returns the process to step S101 described above and continues the process. In a case where it is determined that there is no next action (No in step S112), the control unit 32 ends the processing procedure illustrated in FIG. 19.

The information processing device 30 can compare the prediction probabilities of the action of the operation unit 120 and the object 800 with the conditional expression for executing each assist, and can assist in the remote operation in a case where the conditional expression is satisfied and the assist setting is valid. As a result, the information processing device 30 can realize an assist in remote operation suitable for the operator 900.

### Another Modification of Remote Operation System

In the present embodiment described above, the case where the remote operation system 1 incorporates the information processing device 30 into the robot 100 is described, but the present invention is not limited thereto. For example, the remote operation system 1 may be configured such that the information processing device 30 is realized by a cloud server accessible by the robot 100, and the cloud server controls the motion of the operation unit 120 of the robot 100. In the operation unit 120 of the remote operation system 1, the operation unit 120 may be an operation device, for example.

In the present embodiment, the case where the remote operation system 1 is a system in which the operator 900 performs remote operation of cooking is described. However, the present invention is not limited to this. For example, the remote operation system 1 can be used for remote operation of a medical device, a machine tool, or the like. The remote operation system 1 can be applied to, for example, a remote system such as an endoscope system, a microscope system, or an operation system. The operation system includes, for example, a system that remotely operates work equipment for a work site, a construction site or the like, entertainment imaging equipment, and the like. In addition, the remote operation system 1 can automate the system based on the remote operation by the operator 900 by applying the automatic control in which training is performed on the operation step to the automatic robot.

### Hardware Configuration

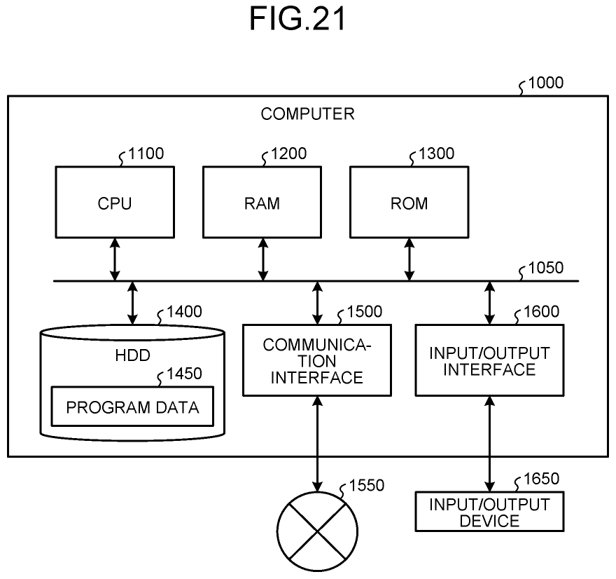

The information processing device 30 according to the above-described embodiment may be implemented by a computer 1000 having a configuration as illustrated in FIG. 21, for example. Hereinafter, the information processing device 30 according to the embodiment will be described as an example. FIG. 21 is a hardware configuration diagram illustrating an example of the computer 1000 that implements the functions of the information processing device 30. The computer 1000 includes a CPU 1100, a RAM 1200, a read only memory (ROM) 1300, a hard disk drive (HDD) 1400, a communication interface 1500, and an input/output interface 1600. Respective units of the computer 1000 are connected by a bus 1050.

The CPU 1100 operates based on a program stored in the ROM 1300 or the HDD 1400, and controls each unit. For example, the CPU 1100 develops a program stored in the ROM 1300 or the HDD 1400 in the RAM 1200, and executes processing corresponding to various programs.

The ROM 1300 stores a boot program such as a basic input output system (BIOS) executed by the CPU 1100 when the computer 1000 is activated, a program depending on hardware of the computer 1000, and the like.

The HDD 1400 is a computer-readable recording medium that non-transiently records programs executed by the CPU 1100, data used by the programs, and the like. Specifically, the HDD 1400 is a recording medium that records an information processing program according to the present disclosure which is an example of program data 1450.

The communication interface 1500 is an interface for the computer 1000 to be connected to an external network 1550 (for example, the Internet). For example, the CPU 1100 receives data from another device or transmits data generated by the CPU 1100 to another device via the communication interface 1500.

The input/output interface 1600 is an interface that connects an input/output device 1650 and the computer 1000. For example, the CPU 1100 receives data from an input device such as a keyboard and a mouse via the input/output interface 1600. In addition, the CPU 1100 transmits data to an output device such as a display, a speaker, or a printer via the input/output interface 1600. Furthermore, the input/output interface 1600 may function as a medium interface that reads a program or the like recorded in a predetermined recording medium (medium). The medium is, for example, an optical recording medium such as a digital versatile disc (DVD), a magneto-optical recording medium such as a magneto-optical disk (MO), a tape medium, a magnetic recording medium, a semiconductor memory, or the like.

For example, in a case where the computer 1000 functions as the information processing device 30 of the remote operation system 1 according to the embodiment, the CPU 1100 of the computer 1000 executes a program loaded on the RAM 1200 to implement the functions of the recognition unit 320, the prediction unit 321, the step prediction unit 322, the motion control unit 323, and the like. In addition, the HDD 1400 stores a program according to the present disclosure and data in the storage unit 31. The CPU 1100 reads the program data 1450 from the HDD 1400 and executes the program data, but as another example, the program may be acquired from another device via the external network 1550.

Although the preferred embodiments of the present disclosure have been described in detail with reference to the accompanying drawings, the technical scope of the present disclosure is not limited to such examples. It is obvious that those skilled in the art in the technical field of the present disclosure can find various revisions and modifications within the scope of a technical concept described in claims, and it should be understood that these revisions and modifications will also be naturally come under the technical scope of the present disclosure.

Furthermore, the effects described in the present specification are merely illustrative or exemplified effects, and are not limitative. That is, the technique according to the present disclosure can accomplish other effects apparent to those skilled in the art from the description of the present specification, in addition to or instead of the effects described above.

Furthermore, it is also possible to create a program for causing hardware such as a CPU, a ROM, and a RAM built in a computer to exhibit a function equivalent to the configuration of the information processing device 30, and a computer-readable recording medium recording the program can also be provided.

Furthermore, each step related to the process of the information processing device 30 of the present specification is not necessarily processed in time series in the order described in the flowchart. For example, each step related to the process of the information processing device 30 may be processed in an order different from the order described in the flowchart, or may be processed in parallel.

### Effects

The information processing device 30 includes the prediction unit 321 that predicts, based on an action executed by the operation unit 120 and the step information D100 capable of identifying a work step, a next action to be executed in a next step by the operation unit 120 in accordance with a remote operation, and the motion control unit 323 that controls the operation unit 120 so as to assist in the remote operation of the operation unit 120 based on a relationship between the predicted next action, the operation information D10 about the remote operation, and the object 800 to be operated by the operation unit 120.

As a result, the information processing device 30 predicts the next action in the next step based on the step information D100, thereby executing the assist suitable for the relationship between the next action, the operation information D10, and the object 800 to be operated. As a result, the information processing device 30 can improve the operability of the operation unit 120 by the remote operation by the operator 900 and simplify the remote operation by the operator 900 by improving the efficiency of the motion of the operation unit 120.

The information processing device 30 further includes the step prediction unit 322 that predicts the action and the object 800 in the step based on the predicted next action, the object information D20 of the object 800, and the operation information D10. The motion control unit 323 controls the operation unit 120 so as to assist in the remote operation of the operation unit 120 based on the prediction result of the action and the object 800.

As a result, the information processing device 30 can predict the relationship between the action and the object 800 in the step and assist the operation unit 120 suitable for the prediction result. As a result, the information processing device 30 can further improve the operability of the operation unit 120 by the remote operation by the operator 900 by assisting in the remote operation suitable for the relationship between the action and the object in the step.

In the information processing device 30, the step prediction unit 322 predicts the prediction of the action and the object 800 in the step and the probability of the prediction, and the motion control unit 323 controls the operation unit 120 so as to assist in the remote operation of the operation unit 120 based on the prediction of the action and the object 800 and the probability of the prediction.

As a result, the information processing device 30 can predict the prediction of the action and the object 800 in the step, and the probability of the prediction, and can assist the operation unit 120 suitable for the probability of the prediction. As a result, the information processing device 30 assists in the remote operation suitable for the probability of prediction, thereby further improving the operability of the operation unit 120 by the remote operation by the operator 900.

In the information processing device 30, the motion control unit 323 controls the operation unit 120 so as to change the track of the operation unit 120 based on the remote operation.

As a result, the information processing device 30 can assist in the remote operation by changing the track of the operation unit 120 based on the remote operation. As a result, the information processing device 30 changes the track to a track of the operation unit 120 suitable for the action even in the remote operation, so that the precise remote operation is unnecessary, and the operability can be improved.

In the information processing device 30, the motion control unit 323 controls the operation unit 120 so as to increase the speed of the operation unit 120 based on the remote operation.

As a result, the information processing device 30 can assist in the remote operation by increasing the speed of the operation unit 120 according to the remote operation. As a result, the information processing device 30 changes the speed of the operation unit 120 according to the action even in the remote operation, so that it is possible to improve the operation efficiency without depending on the skill or the operation technique of the operator 900.

In the information processing device 30, in a case where the probability of the predicted next action satisfies the automation condition, the motion control unit 323 controls the operation unit 120 so that a track corresponding to the next action is obtained.

As a result, in a case where the prediction probability of the next action satisfies the automation condition, the information processing device 30 can automatically control the movement of the operation unit 120 so that a track corresponding to the next action is obtained. As a result, since the information processing device 30 can automate the motion of the operation unit 120 by the operator 900 performing an operation according to the work step, simplification of the operation can be illustrated.

In the information processing device 30, the motion control unit 323 does not control the operation unit based on the remote operation in a case where the remote operation satisfies the invalidation condition.

As a result, in a case where the remote operation satisfies the invalidation condition, the information processing device 30 does not move the operation unit 120 based on the remote operation. As a result, since the information processing device 30 does not receive an invalid operation, it is possible to avoid assisting in an erroneous remote operation, and thus, it is possible to suppress a decrease in work efficiency of the remote operation.

In the information processing device 30, in a case where the relationship between the predicted next action, the operation information D10 about the remote operation, and the object to be operated by the operation unit 120 does not satisfy the predetermined condition, the motion control unit 323 controls the operation unit 120 so as to cause the operation unit to perform motion based on the operation information D10 without assisting in the remote operation.

As a result, the information processing device 30 can move the operation unit 120 in accordance with the remote operation in a case where the predetermined condition for assisting in the remote operation is not satisfied, and can assist in the remote operation in a case where the predetermined condition is satisfied. As a result, by providing a state of not assisting in the remote operation, the information processing device 30 can suppress the occurrence of discomfort in the relationship between the motion of the operation unit 120 and the remote operation.

In the information processing device 30, the prediction unit 321 predicts the next action to be executed in the next step by the operation unit 120 and the object 800 to be operated in accordance with the remote operation in the relationship between the operation unit 120 and the plurality of objects 800.

As a result, the information processing device 30 can predict the next action to be executed in the next step by the operation unit 120 in accordance with the remote operation, and predict the object 800 to be operated from the plurality of objects 800. As a result, even when there is a plurality of objects 800, the information processing device 30 can improve the operability of the operation unit 120 by the remote operation by the operator 900 by improving the efficiency of the motion of the operation unit 120.

In the information processing device 30, the prediction unit 321 predicts the action to be executed in the next step by the operation unit 120 in accordance with the remote operation based on the history of the actions executed by the operation unit 120 and the step information D100.

As a result, the information processing device 30 can predict the next action to be executed in the next step by the operation unit 120 based on the history of actions of the operation unit 120. As a result, the information processing device 30 can further improve the operability of the operation unit 120 by the remote operation by the operator 900 by improving the prediction accuracy of the next action.

In the information processing device 30, the step information D100 includes information capable of identifying a relationship between the action corresponding to at least one of a recipe and a procedure manual and the object.

As a result, the information processing device 30 can predict the next action of the operation unit 120 in which the recipe or the procedure manual exists and assist in the remote operation. As a result, since the information processing device 30 can assist in the remote operation of the cooking or work using the operation unit 120, the operability of the operation unit 120 by the remote operation by the operator 900 can be further improved.

The remote operation system 1 includes the operation unit 120, the information processing device 30, and the operation device 200 that remotely operates the operation unit 120. The information processing device 30 includes the prediction unit 321 that predicts a next action to be executed by the operation unit 120 in a next step in accordance with a remote operation based on an action executed by the operation unit 120 and the step information D100 capable of identifying a work step, and the motion control unit 323 that controls the operation unit 120 so as to assist in a remote operation of the operation unit 120 based on a relationship between the predicted next action, the operation information D10 about the remote operation, and the object 800 to be operated by the operation unit 120.

As a result, the information processing device 30 predicts the next action in the next step based on the step information D100, whereby the remote operation system 1 can assist in the remote operation suitable for the relationship between the next action, the operation information D10 of the operation device 200, and the object 800 to be operated. As a result, the remote operation system 1 can improve the operability of the operation unit 120 by the remote operation by the operator 900 and simplify the remote operation by the operator 900 by improving the efficiency of the motion of the operation unit 120 by the information processing device 30.

In the remote operation system 1, at least one of the operation unit 120 and the information processing device 30 is provided in the robot 100.

As a result, the remote operation system 1 can assist the robot 100 in the remote operation by providing at least one of the operation unit 120 and the information processing device 30 in the robot 100. As a result, the remote operation system 1 can improve the operability of the operation unit 120 by the remote operation by the operator 900 by improving the efficiency of the motion of the operation unit 120 of the robot 100 or the motion of the operation unit 120 outside the robot 100.

An information processing method includes a computer predicting, based on an action executed by the operation unit 120 and the step information D100 capable of identifying a work step, a next action to be executed in a next step by the operation unit 120 in accordance with a remote operation, and controlling the operation unit 120 so as to assist in the remote operation of the operation unit 120 based on a relationship between the predicted next action, the operation information D10 about the remote operation, and the object 800 to be operated by the operation unit 120.

As a result, the information processing method can include the computer predicting the next action in the next step based on the step information D100, thereby executing the assist suitable for the relationship between the next action, the operation information D10, and the object 800 to be operated. As a result, in the information processing method, it is possible to improve the operability of the operation unit 120 by the remote operation by the operator 900 and simplify the remote operation by the operator 900 by improving the efficiency of the motion of the operation unit 120.

Note that the following configuration also belong to the technical scope of the present disclosure.

(1)

An information processing device comprising:
a prediction unit that predicts, based on an action executed by an operation unit and step information capable of identifying a work step, a next action to be executed in a next step by the operation unit in accordance with a remote operation; and
a motion control unit that controls the operation unit so as to assist in the remote operation of the operation unit based on a relationship between the predicted next action, operation information about the remote operation, and an object to be operated by the operation unit.
   (2)

The information processing device according to (1), further comprising:
a step prediction unit that predicts the action and the object in the step based on the predicted next action, object information about the object, and the operation information, wherein
the motion control unit controls the operation unit so as to assist in the remote operation of the operation unit based on a prediction result of the action and the object.
   (3)

The information processing device according to (2), wherein
the step prediction unit predicts a prediction of the action and the object in the step and a probability of the prediction, and wherein
the motion control unit controls the operation unit so as to assist in the remote operation of the operation unit based on the prediction of the action and the object, and the probability of the prediction.
   (4)

The information processing device according to any one of (1) to (3), wherein
the motion control unit controls the operation unit so as to change a track of the operation unit based on the remote operation.
   (5)

The information processing device according to any one of (1) to (4), wherein
the motion control unit controls the operation unit so as to increase a speed of the operation unit based on the remote operation.
   (6)

The information processing device according to any one of (1) to (5), wherein
in a case where a probability of the predicted next action satisfies an automation condition, the motion control unit controls the operation unit so that a track corresponding to the next action is obtained.
   (7)

The information processing device according to any one of (1) to (6), wherein
in a case where the remote operation satisfies an invalidation condition, the motion control unit does not control the operation unit based on the remote operation.
   (8)

The information processing device according to any one of (1) to (7), wherein
in a case where a relationship between the predicted next action, the operation information about the remote operation, and an object to be operated by the operation unit does not satisfy a predetermined condition, the motion control unit controls the operation unit so as to cause the operation unit to perform motion based on the operation information without assisting in the remote operation.
   (9)

The information processing device according to any one of (1) to (8), wherein
the prediction unit predicts the next action to be executed in a next step by the operation unit in accordance with the remote operation and the object to be operated in a relationship between the operation unit and a plurality of the objects.
   (10)

The information processing device according to any one of (1) to (9), wherein
the prediction unit predicts the next action to be executed in a next step by the operation unit in accordance with the remote operation based on a history of the action executed by the operation unit and the step information.
   (11)

The information processing device according to according to any one of (1) to (10), wherein
the step information includes information capable of identifying a relationship between the action corresponding to at least one of a recipe and a procedure manual and the object.
   (12)

A remote operation system comprising:
an operation unit;
an information processing device; and
an operation device that remotely operates the operation unit, wherein
the information processing device includes a prediction unit that predicts a next action to be executed in a next step by the operation unit in accordance with a remote operation based on an action executed by the operation unit and step information capable of identifying a work step, and
a motion control unit that controls the operation unit so as to assist in the remote operation of the operation unit based on a relationship between the predicted next action, operation information about the remote operation, and an object to be operated by the operation unit.
   (13)

The remote operation system according to (12), wherein
at least one of the operation unit and the information processing device is provided in a robot.
   (14)

An information processing method performed by a computer, the method comprising:
predicting, based on an action executed by an operation unit and step information capable of identifying a work step, a next action to be executed in a next step by the operation unit in accordance with a remote operation; and
controlling the operation unit so as to assist in the remote operation of the operation unit based on a relationship between the predicted next action, operation information about the remote operation, and an object to be operated by the operation unit.
   (15)

An information processing program causing a computer to
predicts, based on an action executed by an operation unit and step information capable of identifying a work step, a next action to be executed in a next step by the operation unit in accordance with a remote operation, and
control the operation unit so as to assist in the remote operation of the operation unit based on a relationship between the predicted next action, operation information about the remote operation, and an object to be operated by the operation unit.
   (16)

A robot comprising:
an operation unit; and
an information processing device, wherein
the information processing device includes
a prediction unit that predicts a next action to be executed in a next step by the operation unit in accordance with a remote operation by an operation device based on an action executed by the operation unit and step information capable of identifying a work step, and
a motion control unit that controls the operation unit so as to assist in the remote operation of the operation unit based on a relationship between the predicted next action, operation information about the remote operation, and an object to be operated by the operation unit.

### REFERENCE SIGNS LIST

1 REMOTE OPERATION SYSTEM
10 SENSOR UNIT
11 IMAGING UNIT
12 STATE SENSOR
20 DRIVE UNIT
30 INFORMATION PROCESSING DEVICE
31 STORAGE UNIT
32 CONTROL UNIT
40 COMMUNICATION UNIT
100 ROBOT
120 OPERATION UNIT
200 OPERATION DEVICE
210 DISPLAY UNIT
220 INPUT UNIT
230 COMMUNICATION UNIT
240 STORAGE UNIT
250 CONTROL UNIT
320 RECOGNITION UNIT
321 PREDICTION UNIT
322 STEP PREDICTION UNIT
323 MOTION CONTROL UNIT
D10 OPERATION INFORMATION
D20 OBJECT INFORMATION
D30 STEP PLAN INFORMATION
D100 STEP INFORMATION
D200 HISTORY INFORMATION

1. An information processing device comprising:
a prediction unit that predicts, based on an action executed by an operation unit and step information capable of identifying a work step, a next action to be executed in a next step by the operation unit in accordance with a remote operation; and
a motion control unit that controls the operation unit so as to assist in the remote operation of the operation unit based on a relationship between the predicted next action, operation information about the remote operation, and an object to be operated by the operation unit.

2. The information processing device according to claim 1, further comprising:
a step prediction unit that predicts the action and the object in the step based on the predicted next action, object information about the object, and the operation information, wherein
the motion control unit controls the operation unit so as to assist in the remote operation of the operation unit based on a prediction result of the action and the object.

3. The information processing device according to claim 2, wherein
the step prediction unit predicts a prediction of the action and the object in the step and a probability of the prediction, and wherein
the motion control unit controls the operation unit so as to assist in the remote operation of the operation unit based on the prediction of the action and the object, and the probability of the prediction.

4. The information processing device according to claim 1, wherein
the motion control unit controls the operation unit so as to change a track of the operation unit based on the remote operation.

5. The information processing device according to claim 1, wherein
the motion control unit controls the operation unit so as to increase a speed of the operation unit based on the remote operation.

6. The information processing device according to claim 1, wherein
in a case where a probability of the predicted next action satisfies an automation condition, the motion control unit controls the operation unit so that a track corresponding to the next action is obtained.

7. The information processing device according to claim 1, wherein
in a case where the remote operation satisfies an invalidation condition, the motion control unit does not control the operation unit based on the remote operation.

8. The information processing device according to claim 1, wherein
in a case where a relationship between the predicted next action, the operation information about the remote operation, and an object to be operated by the operation unit does not satisfy a predetermined condition, the motion control unit controls the operation unit so as to cause the operation unit to perform motion based on the operation information without assisting in the remote operation.

9. The information processing device according to claim 1, wherein
the prediction unit predicts the next action to be executed in a next step by the operation unit in accordance with the remote operation and the object to be operated in a relationship between the operation unit and a plurality of the objects.

10. The information processing device according to claim 1, wherein
the prediction unit predicts the next action to be executed in a next step by the operation unit in accordance with the remote operation based on a history of the action executed by the operation unit and the step information.

11. The information processing device according to claim 1, wherein
the step information includes information capable of identifying a relationship between the action corresponding to at least one of a recipe and a procedure manual and the object.

12. A remote operation system comprising:
an operation unit;
an information processing device; and
an operation device that remotely operates the operation unit, wherein
the information processing device includes
a prediction unit that predicts a next action to be executed in a next step by the operation unit in accordance with a remote operation based on an action executed by the operation unit and step information capable of identifying a work step, and
a motion control unit that controls the operation unit so as to assist in the remote operation of the operation unit based on a relationship between the predicted next action, operation information about the remote operation, and an object to be operated by the operation unit.

13. The remote operation system according to claim 12, wherein
at least one of the operation unit and the information processing device is provided in a robot.

14. An information processing method performed by a computer, the method comprising:
predicting, based on an action executed by an operation unit and step information capable of identifying a work step, a next action to be executed in a next step by the operation unit in accordance with a remote operation; and
controlling the operation unit so as to assist in the remote operation of the operation unit based on a relationship between the predicted next action, operation information about the remote operation, and an object to be operated by the operation unit.
